(19) United States
(12) Patent Application Publication
(10) Pub. No.: US 2011/0109727 A1
(43) Pub. Date: May 12, 2011

(54) STEREOSCOPIC IMAGING APPARATUS AND IMAGING CONTROL METHOD

(76) Inventor: Takayuki MATSUURA, Saitama-shi (JP)

(21) Appl. No.: 12/940,708

(22) Filed: Nov. 5, 2010

(30) Foreign Application Priority Data
Nov. 6, 2009 (JP) 2009-255113

(51) Int. Cl. H04N 13/02

(52) U.S. Cl. 348/47; 348/E13.074

(57) ABSTRACT

It is provided that a difference between an exposure amount EVA corresponding to an imaging range of a planar image and an exposure amount EVB corresponding to that of a stereoscopic image is ΔEV. When ΔEV≦a threshold, it is determined that the exposure amount corresponding to the image with smaller imaging range is used; when ΔEV>the threshold, it is determined that the respective EVA and EVB are used. When a difference of an imaging condition other than the exposure amount is within an acceptable range and ΔEV≦the threshold, both of the planar image and the stereoscopic image are taken by one exposure. When ΔEV>the threshold, a first image is taken by an exposure with the smaller one of the exposure amounts and a second image is taken by an exposure with ΔEV, and then the first and second images are combined.

### BACKGROUND OF THE INVENTION

1. Field of the Invention

The presently disclosed subject matter relates to a stereoscopic imaging apparatus including a plurality of imaging devices and an imaging control method using the plurality of imaging devices, and particularly to an stereoscopic imaging apparatus and an imaging control method which are capable of taking a planar image and a stereoscopic image under respective appropriate conditions and of reducing a time lag between the planar image and the stereoscopic image when an imaging range of the planar image and an imaging range of the stereoscopic image are different from each other.

2. Description of the Related Art

A 3D digital camera which includes a plurality of imaging systems each having an imaging optical system and an imaging element and is capable of switching between a 2D imaging mode for storing a 2D image (planar image) including an taken image acquired by imaging through one of the imaging systems and a 3D imaging mode for storing a stereoscopically viewable 3D image (stereoscopic image) including a plurality of taken images acquired by the plurality of imaging systems, is provided for users.

Japanese Patent Application Laid-Open No. 7-110505 discloses a configuration which includes an operation device for switching between a panorama imaging mode and a 3D imaging mode, performs metering (center-weighted averaging metering) weighting a central portion of an image with respect to one of the imaging systems in the 3D imaging mode, and performs metering (composite-weighted averaging metering) weighting a central portion of a composite image in which two images are combined in the panorama imaging mode.

Japanese Patent Application Laid-Open No. 5-341172 discloses a configuration which includes an operation device for switching between a normal imaging mode and a screen restriction imaging mode, and focuses focusing lenses on the basis of the defocus amount corresponding to the farthest subject among a plurality of defocus amounts detected in a plurality of focus detection areas when the screen restriction imaging mode is selected.

### SUMMARY OF THE INVENTION

The 3D imaging cuts out and stores a range common to a plurality of taken images in an effective pixel region as an imaging range, in order to allow stereoscopy by adjusting an amount of parallax. On the other hand, the 2D imaging preferably specifies a range as wide as possible in the effective pixel region. In such cases, the imaging range of the 2D image is wider than the imaging range of the 3D image. Accordingly, the 3D image is sometimes different from the 2D image in the optimal focus position and exposure amount.

It is also required to take both a 2D image and a 3D image. However, if a 2D image is taken with a first exposure and a 3D image is taken with a second exposure, a time lag occurs between the first exposure and the second exposure. Owing thereto, a user who compares the 2D image and the 3D image feels strangeness.

The presently disclosed subject matter is made in view of these situations. It is an object of the presently disclosed subject matter to provide an stereoscopic imaging apparatus and an imaging control method which are capable of taking a planar image and a stereoscopic image under respective appropriate conditions and of reducing a time lag between the planar image and the stereoscopic image when an imaging range of the planar image is different from an imaging range of the stereoscopic image.

In order to attain the object, the presently disclosed subject matter provides a stereoscopic imaging apparatus capable of taking a planar image and a stereoscopic image, comprising: a first imaging device having a first imaging optical system and a first imaging element imaging a subject through the first imaging optical system; a second imaging device having a second imaging optical system and a second imaging element imaging the subject through the second imaging optical system; an exposure amount detection device which detects a first exposure amount corresponding to an imaging range of the planar image and a second exposure amount corresponding to an imaging range of the stereoscopic image; an exposure amount determination device which determines to acquire the planar image and the stereoscopic image with one of the first exposure amount and the second exposure amount corresponding to an image whose imaging range is smaller when a difference between the first exposure amount and the second exposure amount is smaller than or equal to a threshold, and determines to acquire the planar image with the first exposure amount and to acquire the stereoscopic image with the second exposure amount when the difference between the first exposure amount and the second exposure amount is larger than the threshold; and a control device for controlling the first and the second imaging devices according to a determination result by the exposure amount determination device, the control device which acquires both of the planar image and the stereoscopic image by one exposure when the difference between the exposure amounts is smaller than or equal to the threshold, and performs exposure with the smaller one of the first exposure amount and the second exposure amount to generate a first taken image and performs exposure with the difference between the first exposure amount and the second exposure amount to generate a second taken image and combines the first taken image and the second taken image when the difference between the exposure amounts is larger than the threshold, if a difference of imaging conditions other than the exposure amount between the planar image and the stereoscopic image is within an acceptable range.

That is, when the difference between the first exposure amount corresponding to the imaging range of the planar image and the second exposure amount corresponding to the imaging range of the stereoscopic image is within an acceptable range, the planar image and the stereoscopic image which are taken with an appropriate exposure amount common to each other can be acquired without a time lag. When the difference between the exposure amounts is out of the acceptable range, the planar image and the stereoscopic image taken with the respective optimal exposure amounts can be acquired. Further, because the first taken image by the exposure with the smaller exposure amount and the second taken image taken by the exposure with the difference between the exposure amounts are combined, the time lag between the planar image and the stereoscopic image can be reduced.

The presently disclosed subject matter also provides a stereoscopic imaging apparatus capable of taking a planar image and a stereoscopic image, comprising: a first imaging device having a first imaging optical system and a first imaging element imaging a subject through the first imaging optical system; a second imaging device having a second imaging optical system and a second imaging element imaging the subject through the second imaging optical system; a focus position detection device which detects a first focus position corresponding to an imaging range of the planar image and a second focus position corresponding to an imaging range of the stereoscopic image; an aperture value selection device which selects an aperture value where a difference between the first focus position and the second focus position is included in depths of field of the first and second imaging optical systems, from among a plurality of aperture values settable to the imaging optical systems; a focus position determination device which determines to acquire the planar image in the first focus position and acquire the stereoscopic image in the second focus position when the aperture value where the difference between the focus positions is included in the depths of field does not exist, and determines to acquire the planar image and the stereoscopic image in a focus position corresponding to an image whose imaging range is smaller between the first focus position and the second focus position when the aperture value where the difference between the focus positions is included in the depths of field exists; and a control device for controlling the first and second imaging devices according to a determination result by the focus position determination device, the control device which acquires both of the planar image and the stereoscopic image by one exposure when a difference of imaging conditions other than the focus position between the planar image and the stereoscopic image is within an acceptable range and when the difference between the focus positions is included within the depths of field.

That is, when the difference between the first focus position corresponding to the imaging range of the planar image and the second focus position corresponding to the imaging range of the stereoscopic image is within the depths of field, the planar image and the stereoscopic image which are taken in an appropriate focus position common to each other can be acquired without a time lag. Because the aperture value where the difference between the focus positions is included in the depths of field of the imaging optical systems is selected from among the aperture values settable to the imaging optical systems, it is possible to reduce the time lag between the planar image and the stereoscopic image.

Further, the presently disclosed subject matter provides a stereoscopic imaging apparatus capable of taking a planar image and a stereoscopic image, comprising: a first imaging device having a first imaging optical system and a first imaging element imaging a subject through the first imaging optical system; a second imaging device having a second imaging optical system and a second imaging element imaging the subject through the second imaging optical system; an exposure amount detection device which detects a first exposure amount corresponding to an imaging range of the planar image and a second exposure amount corresponding to an imaging range of the stereoscopic image; a focus position detection device which detects a first focus position corresponding to the imaging range of the planar image and a second focus position corresponding to the imaging range of the stereoscopic image; an exposure amount determination device which determines to acquire the planar image and the stereoscopic image with one of the first exposure amount and the second exposure amount corresponding to an image whose imaging range is smaller when a difference between the first exposure amount and the second exposure amount is smaller than or equal to a threshold, and determines to acquire the planar image with the first exposure amount and to acquire the stereoscopic image with the second exposure amount when the difference between the first exposure amount and the second exposure amount is larger than the threshold; an aperture value selection device which selects an aperture value where a difference between the first focus position and the second focus position is included in the depths of field of the first and second imaging optical systems, from among a plurality of aperture values settable to the imaging optical systems; a focus position determination device which determines to acquire the planar image in the first focus position and acquire the stereoscopic image in the second focus position when the aperture value where the difference between the focus positions is included in the depths of field does not exist, and determines to acquire the planar image and the stereoscopic image in a focus position corresponding to an image whose imaging range is smaller between the first focus position and the second focus position when the aperture value where the difference between focus positions is included in the depths of field exists; and a control device for controlling the first and second imaging devices according to determination results by the exposure amount determination device and the focus position determination device, the control device which acquires both of the planar image and the stereoscopic image by one exposure when the difference between the exposure amounts is smaller than or equal to the threshold, and performs exposure with a smaller one of the first exposure amount and the second exposure amount to generate a first taken image and performs exposure with the difference between the first exposure amount and the second exposure amount to generate a second taken image and combines the first taken image and the second taken image when the difference between the exposure amounts is larger than the threshold, if the difference between the focus positions is within the depths of field.

In an aspect of the presently disclosed subject matter, the exposure amount detection device divides the taken images of the first imaging device and the second imaging device into a plurality of blocks, acquires an evaluation value for detecting the exposure amount with respect to each of the blocks, detects the first exposure amount on the basis of the evaluation values of the plurality of blocks belonging to the imaging range of the planar image, detects the second exposure amount on the basis of the evaluation values of the plurality of blocks belonging to the imaging range of the stereoscopic image, and thereby detects both exposure amounts of the planar image and the stereoscopic image by one acquisition operation of evaluation values.

That is, one acquisition operation of evaluation value is sufficient to detect the both of the exposure amounts of the planar image and the stereoscopic image. Accordingly, imaging of the planar image and the stereoscopic image can be performed in a short time.

In an aspect of the presently disclosed subject matter, the focus position detection device divides the taken images of the first imaging device and the second imaging device into a plurality of blocks, acquires an evaluation value for detecting the focus position with respect to each of the blocks, detects the first focus position on the basis of the evaluation values of the plurality of blocks belonging to the imaging range of the planar image, detects the second focus position on the basis of the evaluation values of the plurality of blocks belonging to the imaging range of the stereoscopic image, and thereby detects both focus positions of the planar image and the stereoscopic image by one acquisition operation of evaluation values.

That is, one acquisition operation of evaluation value is sufficient to detect the both of the focus positions of the planar image and the stereoscopic image. Accordingly, imaging of the planar image and the stereoscopic image can be performed in a short time. Particularly, in a case where focus position detection is performed according to a contrast system in which a focus evaluation value is acquired while moving the focus lens, search time can be reduced.

In an aspect of the presently disclosed subject matter, the control device images the subject through only one of the first imaging device and the second imaging device when taking only the planar image.

That is, since only one of the imaging devices performs imaging when taking only the planar image, memory capacity and power consumption can be saved.

Further, the presently disclosed subject matter provides an imaging control method using a first imaging device having a first imaging optical system and a first imaging element imaging a subject through the first imaging optical system and generating a first taken image, and a second imaging device having a second imaging optical system and a second imaging element imaging the subject through the second imaging optical system and generating a second taken image, and taking a planar image and a stereoscopic image, comprising: an exposure amount detection step for detecting a first exposure amount corresponding to an imaging range of the planar image and a second exposure amount corresponding to an imaging range of the stereoscopic image; an exposure amount determination step for determining to acquire the planar image and the stereoscopic image with one of the first exposure amount and the second exposure amount corresponding to an image whose imaging range is smaller when a difference between the first exposure amount and the second exposure amount is smaller than or equal to a threshold, and determining to acquire the planar image with the first exposure amount and to acquire the stereoscopic image with the second exposure amount when the difference between the first exposure amount and the second exposure amount is larger than the threshold; and a control step for controlling the first and second imaging devices according to a result of the exposure amount determination step, the control step which includes: acquiring both of the planar image and the stereoscopic image by one exposure when the difference between the exposure amounts is smaller than or equal to the threshold; and performing exposure with a smaller one of the first exposure amount and the second exposure amount to generate a first taken image, performing exposure with the difference between the first exposure amount and the second exposure amount to generate a second taken image and combining the first taken image and the second taken image when the difference between the exposure amounts is larger than the threshold, if a difference of imaging conditions other than the exposure amount between the planar image and the stereoscopic image is within an acceptable range.

Moreover, the presently disclosed subject matter provides an imaging control method using a first imaging device having a first imaging optical system and a first imaging element imaging a subject through the first imaging optical system and generating a first taken image, and a second imaging device having a second imaging optical system and a second imaging element imaging the subject through the second imaging optical system and generating a second taken image, and taking a planar image and a stereoscopic image, comprising: a focus position detection step for detecting a first focus position corresponding to an imaging range of the planar image and a second focus position corresponding to an imaging range of the stereoscopic image; an aperture value selection step for selecting an aperture value where a difference between the first focus position and the second focus position is included in depths of field of the first and second imaging optical systems from among a plurality of aperture values settable to the first and second imaging optical systems; a focus position determination step for determining to acquire the planar image in the first focus position and acquire the stereoscopic image in the second focus position when the aperture value where the difference between the focus positions is included in the depths of field does not exist, and determining to acquire the planar image and the stereoscopic image in a focus position corresponding to an image whose imaging range is smaller between the first focus position and the second focus position when the aperture value where the difference between the focus positions is included in the depth of fields exists; and a control step for controlling the first and second imaging devices according to a result of the focus position determination step, the control step which includes acquiring both of the planar image and the stereoscopic image by one exposure when a difference of imaging conditions other than the focus position between the planar image and the stereoscopic image is within an acceptable range and when the difference between focus positions is included within the depths of field.

Furthermore, the presently disclosed subject matter provides an imaging control method using a first imaging device having a first imaging optical system and a first imaging element imaging a subject through the first imaging optical system and generating a first taken image, and a second imaging device having a second imaging optical system and a second imaging element imaging the subject through the second imaging optical system and generating a second taken image, and taking a planar image and a stereoscopic image, including: an exposure amount detection step for detecting a first exposure amount corresponding to an imaging range of the planar image and a second exposure amount corresponding to an imaging range of the stereoscopic image; a focus position detection step for detecting a first focus position corresponding to the imaging range of the planar image and a second focus position corresponding to the imaging range of the stereoscopic image; an exposure amount determination step for determining to acquire the planar image and the stereoscopic image with one of the first exposure amount and the second exposure amount corresponding to an image whose imaging range is smaller when a difference between the first exposure amount and the second exposure amount is smaller than or equal to a threshold, and determining to acquire the planar image with the first exposure amount and to acquire the stereoscopic image with the second exposure amount when the difference between the first exposure amount and the second exposure amount is larger than the threshold; an aperture value selection step for selecting an aperture value where a difference between the first focus position and the second focus position is included in the depths of field of the first and second imaging optical systems, from among a plurality of aperture values settable to the imaging optical systems; a focus position determination step for determining to acquire the planar image in the first focus position and acquire the stereoscopic image in the second focus position when the aperture value where the difference between the focus positions is included in the depths of field does not exist, and determining to acquire the planar image and the stereoscopic image in a focus position corresponding to an image whose imaging range is smaller between the first focus position and the second focus position when the aperture value where the difference between the focus positions is included in the depths of field exists; and a control step for controlling the first and second imaging device according to a result of the exposure amount determination step and a result of the focus position determination step, the control step which includes: acquiring both of the planar image and the stereoscopic image by one exposure when the difference between the exposure amounts is smaller than or equal to the threshold; and performing exposure with a smaller one of the first exposure amount and the second exposure amount to generate a first taken image, performing exposure with the difference between the first exposure amount and the second exposure amount to generate a second taken image and combining the first taken image and the second taken image when the difference between the exposure amounts is larger than the threshold, if the difference between the focus positions is within the depths of field.

In an aspect of the presently disclosed subject matter, the exposure amount detection step includes: dividing the taken images of the first imaging device and the second imaging device into a plurality of blocks; acquiring an evaluation value for detecting the exposure amount with respect to each of the blocks; and detecting the first exposure amount on the basis of the evaluation values of the plurality of blocks belonging to the imaging range of the planar image, and detecting the second exposure amount on the basis of the evaluation values of the plurality of blocks belonging to the imaging range of the stereoscopic image, thereby detecting both exposure amounts of the planar image and the stereoscopic image by one acquisition operation of evaluation values.

In an aspect of the presently disclosed subject matter, the focus position detection step includes: dividing the taken images of the first imaging device and the second imaging device into a plurality of blocks; acquiring an evaluation value for detecting the focus position with respect to each of the blocks; and detecting the first focus position on the basis of the evaluation values of the plurality of blocks belonging to the imaging range of the planar image, and detecting the second focus position on the basis of the evaluation values of the plurality of blocks belonging to the imaging range of the stereoscopic image, thereby detecting both focus positions of the planar image and the stereoscopic image by one acquisition operation of evaluation values.

In an aspect of the presently disclosed subject matter, the control step includes imaging the subject through only one of the first imaging device and the second imaging device when taking only the planar image.

According to the presently disclosed subject matter, when the imaging range of the planar image and the imaging range of the stereoscopic image are different from each other, the planar image and the stereoscopic image can be taken under appropriate imaging conditions, respectively, and the time lag between the planar image and the stereoscopic image can be reduced.

### BRIEF DESCRIPTION OF THE DRAWINGS

FIG. 1 is a block diagram showing an overall configuration of a digital camera which is an example of a stereoscopic imaging apparatus according to the presently disclosed subject matter;

FIGS. 2A and 2B are diagrams used for illustrating 3D imaging and 3D display;

FIG. 3 is a principal block diagram of a digital camera according to a first embodiment;

FIG. 4 is a diagram used for illustrating an example of an imaging scene;

FIGS. 5A and 5B are diagrams used for illustrating a difference between the imaging range of a 2D image and the imaging range of a 3D image;

FIG. 6 is a block diagram showing the details of a detection area determination unit, an imaging condition detector and an imaging condition determination unit;

FIG. 7 is a first flowchart showing the flow of an example of an imaging process according to the first embodiment;

FIG. 8 is a second flowchart showing the flow of the example of the imaging process according to the first embodiment;

FIG. 9 is a diagram illustrating an example of an array of detection blocks defined in an image area;

FIG. 10 is a diagram illustrating an example of an imaging condition detection area of a 2D image;

FIGS. 11A and 11B are diagrams showing examples of imaging condition detection areas of a 3D image;

FIG. 12 is a diagram used for illustrating imaging control in the first embodiment;

FIGS. 13A and 13B are diagrams for illustrating multiframe combination;

FIG. 14 is a principal block diagram of a digital camera according to a second embodiment;

FIG. 15 is a flowchart showing the flow of an example of an imaging process according to the second embodiment;

FIG. 16 is a diagram used for illustrating imaging control according to the second embodiment;

FIG. 17 is a principal block diagram of a digital camera according to a third embodiment;

FIG. 18 is a flowchart showing the flow of an example of an imaging process according to the third embodiment;

FIG. 19 is a diagram used for illustrating imaging control in the third embodiment; and

FIG. 20 is a diagram used for illustrating imaging control in a fourth embodiment.

### DETAILED DESCRIPTION OF THE PREFERRED EMBODIMENTS

Embodiments of the presently disclosed subject matter will hereinafter be described in detail according to the accompanying drawings.

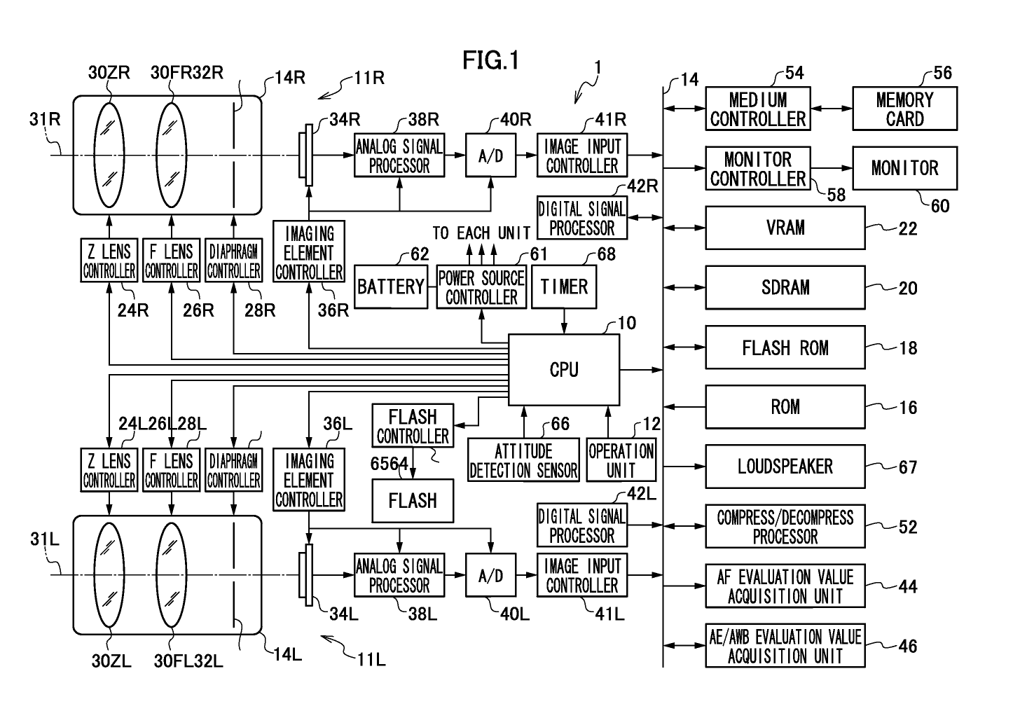

FIG. 1 is a block diagram showing an overall configuration of a digital camera 1, which is an example of a stereoscopic imaging apparatus of the presently disclosed subject matter.

In FIG. 1, the digital camera 1 is a stereoscopic imaging apparatus capable of imaging the same subject from a plurality of viewpoints and generating a 3D image (stereoscopic image). The digital camera 1 includes a CPU (Central Processing Unit) 10, imaging systems 11 (11R and 11L), an operation unit 12, a ROM (Read Only Memory) 16, a flash ROM 18, an SDRAM (Synchronous Dynamic Random Access Memory) 20, a VRAM (Video RAM) 22, zoom lens controllers 24 (24L and 24R), focusing lens controllers 26 (26L and 26R), diaphragm controllers 28 (28L and 28R), imaging element controllers 36 (36L and 36R), analog signal processors 38 (38L and 38R), A/D converters 40 (40L and 40R), image input controllers 41 (41L and 41R), digital signal processors 42 (42L and 42R), an AF (Auto-focus) evaluation value acquisition unit 44, an AE/AWB (Auto-exposure/Auto-white balance) evaluation value acquisition unit 46, a compress/decompress processor 52, a medium controller 54, a memory card 56, a monitor controller 58, a monitor 60, a power source controller 61, a battery 62, a flash controller 64, a flash 65, an attitude detection sensor 66, a loudspeaker 67 and a timer 68.

The imaging system 11L for the left eye (also referred to as a “left imaging device”) mainly includes an imaging optical system 14L, the zoom lens controller 24L, the focusing lens controller 26L, the diaphragm controller 28L, the imaging element 34L, the imaging element controller 36L, the analog signal processor 38L, the A/D (Analog to Digital) converter 40L, the image input controller 41L and the digital signal processor 42L.

The imaging system 11R for the right eye (also referred to as a “right imaging device”) mainly includes an imaging optical system 14R, the zoom lens controller 24R, the focusing lens controller 26R, the diaphragm controller 28R, the imaging element 34R, the imaging element controller 36R, the analog signal processor 38R, the A/D converter 40R, the image input controller 41R and the digital signal processor 42R.

In this specification, an image signal acquired by imaging a subject through the imaging systems 11L and 11R is referred to as “taken image”. A taken image acquired through the imaging system 11L for the left eye is referred to as a “left taken image”. A taken image acquired through the imaging system 11R for the right eye is referred to as a “right taken image”.

The CPU 10 functions as a control device which controls the overall operation of the digital camera including imaging and reproduction. The CPU 10 controls each element according to a program on the basis of an input from the operation unit 12.

The operation unit 12 includes a shutter release button, a power switch, a mode switch, a zoom button, a cross button, a menu button, an OK button and a BACK button. The shutter release button includes a two-step stroke switch capable of so-called “half-press” and “full-press”. The power switch is a switch for switching power-on and power-off of the digital camera 1. The mode switch is a switch for switching various modes. The zoom button is used for zoom operation. The cross button is capable of being operated in four directions, up, down, right and left, and used for various setting operations along with the menu button, the OK button and the BACK button.

Programs executed by the CPU 10 and various pieces of data necessary for control by the CPU 10 are stored in the ROM 16 connected via the bus 14. Various pieces of setting information pertaining to operations of the digital camera I such as user setting information are stored in the flash ROM 18. The SDRAM 20 is used for an operation working region for the CPU 10, and also used for a temporary storing region for image data. The VRAM 22 is used for a temporary storing region dedicated for image data to be displayed.

The pair of left and right imaging optical systems include zoom lenses 30ZL and 30ZR, focusing lenses 30FL and 30FR and diaphragms 32L and 32R.

The zoom lenses 30ZR and 30ZL are driven by the respective zoom lens controllers 24R and 24L, which are zoom lens driving devices, and move forward and backward along the optical axis. The CPU 10 controls the positions of the zoom lenses 30ZL and 30ZR via the zoom lens controllers 24L and 24R, and zooms the imaging optical systems 14L and 14R, respectively.

The focusing lenses 30FL and 30FR are driven by the focusing lens controllers 26L and 26R, which are focusing lens driving devices, and move forward and backward along the optical axis. The CPU 10 controls the positions of the focusing lenses 30FL and 30FR via the focusing lens controllers 26L and 26R, and focuses the imaging optical systems 14L and 14R.

The diaphragm 32L and 32R may be iris diaphragms. The diaphragm 32L and 32R are driven by the respective diaphragm controllers 28L and 28R, which are diaphragm driving devices, thereby changing aperture amounts (aperture values). The CPU 10 controls the aperture amounts of the diaphragms via the diaphragm controllers 28L and 28R, and controls the exposure amounts of the imaging elements 34L and 34R, respectively.

The imaging elements 34L and 34R may be color CCD (Charge Coupled Device) imaging elements having a prescribed color filter arrangement. Multiple photodiodes are two-dimensionally arranged on the light receiving surface of the CCD. Optical images (subject images) of the subject image-formed on the light receiving surfaces of the CCDs through the respective imaging optical systems 14L and 14R are converted into signal charges according to incident intensities of light by the photodiodes. The signal charges accumulated in the photodiodes are sequentially read as voltage signals (image signals) according to the signal charges on the basis of driving pulses provided from the imaging element controllers 36L and 36R pursuant to instruction from the CPU 10, from the imaging elements 34L and 34R. The imaging elements 34L and 34R include functions of electronic shutters, and by controlling the charge accumulation time in the photodiodes, exposure time (shutter speed) is controlled. In this example, the CCD is used as the imaging element. However, an imaging element having another configuration such as a CMOS (Complementary Metal-oxide Semiconductor) sensor may be employed.

When the CPU 10 drives the zoom lenses 30ZL and 30ZR, the focusing lenses 30FL and 30FR and the diaphragms 32L and 32R, which configure the respective imaging optical systems 14L and 14R, the CPU 10 drives the left and right imaging optical systems 14L and 14R in synchronization with each other. More specifically, the CPU 10 sets the left and right imaging optical systems 14L and 14R so as to have the same focal length (zoom magnification), and sets the positions of the focusing lenses 30FL and 30FR so as to be always focused on the same subject. Further, the aperture values and the exposure times (shutter speeds) are adjusted to always acquire the same exposure amount.

The analog signal processors 38L and 38R include correlated double sampling circuits (CD) for eliminating reset noise (low frequency) included in the image signals output from the imaging elements 34L and 34R, and AGC (Automatic Gain Control) circuits for amplifying and controlling the image signals to a certain intensity level. The analog signal processors 38L and 38R apply a correlated double sampling process to the image signals output from the imaging elements 34L and 34R and amplify the signals. The A/D converters 40L and 40R convert the analog image signals output from the analog signal processors 38L and 38R into digital image signals. The image input controllers 41L and 41R capture image signals output from the A/D converters 40L and 40R and store the signals in the SDRAM 20. In this example, the left and right taken images are temporarily stored in the SDRAM 20. The digital signal processors 42L and 42R capture the image signals stored in the SDRAM 20 according to instructions from the CPU 10, apply prescribed signal processing and generate image data (Y/C signal) including luminance signals Y and color-difference signals Cr and Cb. Further, the digital signal processors 42L and 42R apply various digital corrections, such as an offset process, a white balance adjustment process, a gamma correction process, an RGB interpolation process, an RGB/YC conversion process, a noise reduction process, a contour correction process, a color tone correction and a light source type determination process, according to instructions from the CPU 10. The digital signal processors 42L and 42R may be configured by hardware circuits. Instead, the same functions may be configured by software.

The AF evaluation value acquisition unit 44 calculates an AF evaluation value (focus evaluation value) for detecting the focus positions of the focusing lenses 30FL and 30FR, on the basis of R, G and B colors of image signals (taken image) written in the SDRAM 20 by one of the image input controllers 41R and 41L. The AF evaluation value acquisition unit 44 in this embodiment divides the taken image into a plurality of detection blocks (e.g., 8×8=64 blocks) and calculates the AF evaluation values on the respective detection blocks. The AF evaluation value acquisition unit 44 in this embodiment includes a high-pass filter for passing only a high frequency component of a G signal, a signal extraction section for cutting out signals in the respective detection blocks and an integrator for integrating absolute values of the signals in the respective detection blocks, and outputs the integrated values in the respective blocks as the AF evaluation value. The AF evaluation value of this embodiment represents degrees of focus in the respective detection blocks.

The CPU 10 detects a lens position (focus position) where the AF evaluation value output from the AF evaluation value acquisition unit 44 becomes the local maximum in a focus area including a plurality of blocks in AF control, and moves the focusing lenses 30FL and 30FR to the lens position, thereby focusing the focusing lenses 30FL and 30FR. For example, the CPU 10 moves the focusing lenses 30FL and 30FR from close-up to infinity. In the movement process, the CPU 10 successively acquires AF evaluation values from the AF evaluation value acquisition unit 44, detects the lens position where the AF evaluation value becomes the local maximum in the focus position detection area, and moves the focusing lenses 30FL and 30FR to the lens position (focus position). Accordingly, the subject (principal subject) can be in focus in the focus area within an angle of view.

The AE/AWB evaluation value acquisition unit 46 calculates an evaluation value necessary for AE (automatic exposure) control and AWB (automatic white balance adjustment) control, on the basis of the R, G and B colors of image signals (taken image) written in the SDRAM 20 by the one of the image input controllers 41. The AE/AWB evaluation value acquisition unit 46 in this embodiment divides the taken image into the plurality of detection blocks (e.g., 8×8=64 blocks) and calculates an integrated value of the R, G and B signals in the respective detection blocks as the AE evaluation value and the AWB evaluation value.

In the AE control, the CPU 10 calculates the exposure amount on the basis of the AE evaluation value. More specifically, the CPU 10 determines a sensitivity, an aperture value, a shutter speed, necessity of flash and the like.

In the AWB control, the CPU 10 acquires an AWB evaluation value, calculates a gain value for white balance adjustment, and detects a light source type.

The compress/decompress processor 52 applies a compression process with a prescribed format to the input image data and generates compressed image data, according to an instruction from the CPU 10. Further, the compress/decompress processor 52 applies a decompression process with a prescribed format to the input image data and generates decompressed image data, according to an instruction from the CPU 10.

The medium controller 54 controls the memory card 56 to read and write data, according to an instruction from the CPU 10.

The monitor controller 58, controls display on the monitor 60, according to an instruction from the CPU 10. The monitor 60 is used as a image display unit for displaying an image having been taken, and as a GUI (Graphic User Interface) when various settings are performed. When an image is taken, the monitor 60 successively displays images (through images) continuously captured by the imaging elements 34R and 34L and used as an electronic viewfinder.

The power source controller 61 controls power supply from the battery 62 to each element, according to an instruction from the CPU 10. The flash controller 64 controls light emission of the flash 65 according to an instruction from the CPU 10. The attitude detection sensor 66 detects the attitude (upward, downward, right and left inclinations) of the body of the digital camera 1, and outputs the result thereof to the CPU 10. More specifically, the attitude detection sensor 66 detects inclination angles (rotation angle of the imaging optical systems 14L and 14R about the optical axes) of the body of the digital camera 1 in right and left directions and inclination angles (inclination angles of the optical axes of the imaging optical systems 14L and 14R in upward and downward directions) of the body of the digital camera 1 in upward and downward directions. The loudspeaker 67 outputs sound. The timer 68 times the present date and time, and measures the time according to an instruction from the CPU 10.

In this specification, “2D” means a plane, and “3D” means stereoscopy. 2D imaging means imaging and storing of a taken image from a single viewpoint (referred to as a “2D image” or a “planar image”). 2D display means display of the 2D image. 3D imaging means imaging and storing of taken images from a plurality of viewpoints (referred to as “3D images” or “stereoscopic images”). 3D display means display of the 3D image in a stereoscopically viewable manner.

For example, a 3D liquid crystal monitor according to a light direction control system is used as the stereoscopically viewable monitor 60. In the light detection control system, the directions of backlight illuminating a liquid crystal display device configuring the monitor 60 are controlled in the directions of the right and left eyes of the observer. An example of the light direction control system is disclosed in Japanese Patent Application Laid-Open No. 2004-20684 and the like. A scan backlight system, which is disclosed in Japanese Patent No. 3930021 and the like, may be used.

Further, a 3D liquid crystal monitor according to a parallax barrier system may be employed. In the parallax barrier system, the right and left taken images are respectively cut into narrow rectangles extending in the vertical direction on the image, displayed in an alternately arranged manner, and the observer watches the images through slits cut in the vertical direction. Accordingly, the right and left images are projected in the right and left eyes of the observer, respectively. Another spatial division system may be employed.

Moreover, a monitor 60 including lenticular lens having semi-cylindrical lenses may be employed. Further, stereoscopy may be realized by alternately displaying the right and left images and making the observer wear image separation glasses.

The monitor 60 is not restricted to the liquid crystal device. For example, an organic EL display may be employed instead.

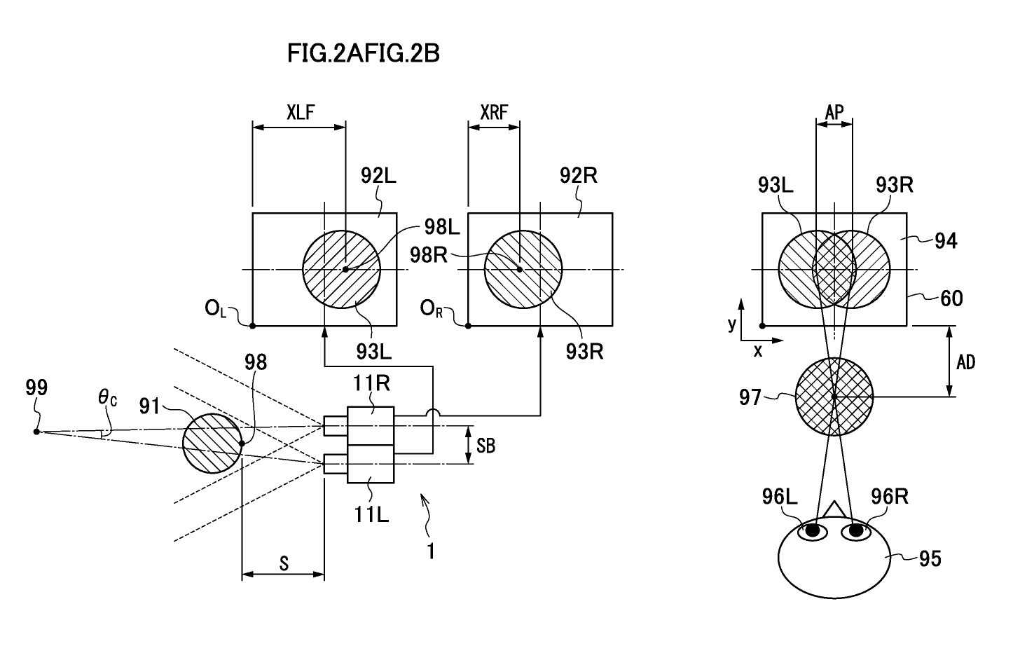

Next, referring to FIGS. 2A and 2B, an overview of 3D imaging (stereoscopic imaging) and 3D display (stereoscopic display) in the digital camera 1 shown in FIG. 1 will be described.

First, for the sake of facilitating understanding the invention, the description will be made under conditions that the base line length SB (the distance between the optical axes of the imaging system 11L and 11R in the digital camera 1) and the convergence angle θc (the angle formed between the optical axes of the imaging systems 11L and 11R) are fixed.

The plurality of imaging systems 11L and 11R image the same specific object 91 (e.g., sphere) from a plurality of viewpoints, thereby generating a plurality of taken images (the left taken image 92L and the right taken image 92R). The generated taken images 92L and 92R include specific object images 93L and 93R, respectively, where the same specific object 91 has been projected. A 3D display image 94 is reproduced by displaying these taken images 92L and 92R on the monitor 60 capable of stereoscopic display in a superimposed manner, i.e., by 3 dimensionally displaying. The 3D display image 94 is composed of the left taken image 92L and the right taken image 92 R. The observer 95 observes the 3D display image 94 on the monitor 60 by the two eyes 96R and 96L. This allows the observer 95 to see the virtual image 97 of the specific object 91 (e.g. sphere) in a pop-up manner (in a protruded manner). In FIGS. 2A and 2B, since the specific object 91 resides at a position nearer than the cross point 99 between the optical axes, the virtual image 97 appears in the pop-up manner. However, if the specific object resides at a position farther away from the cross point 99, the virtual image appears in a recessed manner.

Within a region where the subject distance S is smaller than the distance to the cross point 99 of the optical axes of the imaging systems 11L and 11R as shown in FIGS. 2A and 2B, the smaller the subject distance S, the larger the difference |XLF−XRF| between the central coordinates XLF and XRF (only x coordinates are shown in FIGS. 2A and 2B) of the specific object images 93L and 93R on the taken images 92L and 92R becomes. That is, the smaller the subject distance S is, the farther the corresponding points on the taken images taken from the respective view points are apart from each other. The difference |XLF−XRF| is with respect only to the x coordinates. This difference is represented as an amount of binocular parallax AP. That is, provided that the base line length SB and the convergence angle θc are determined, the smaller the subject distance S is, the larger AP becomes, and the larger the pop-up amount AD which the observer 95 actually senses becomes.

The case where the base line length SB and the convergence angle θc are constant has been described. In cases of a structure where the convergence angle θc is variable, the pop-up amount AD is changed according to the convergence angle θc and the subject distance S. In a case where the base line length SB is also variable in addition to the convergence angle θc, the pop-up amount AD is changed according to the base line length SB, the convergence angle θc and the subject distance S.

Even if the base line length SB and the convergence angle θc are constant, the pop-up amount AD can be changed by shifting the pixels between the taken images 92L and 92R so as to change the amount of binocular parallax AP.

The presently disclosed subject matter will hereinafter be described in a manner separated into various embodiments.

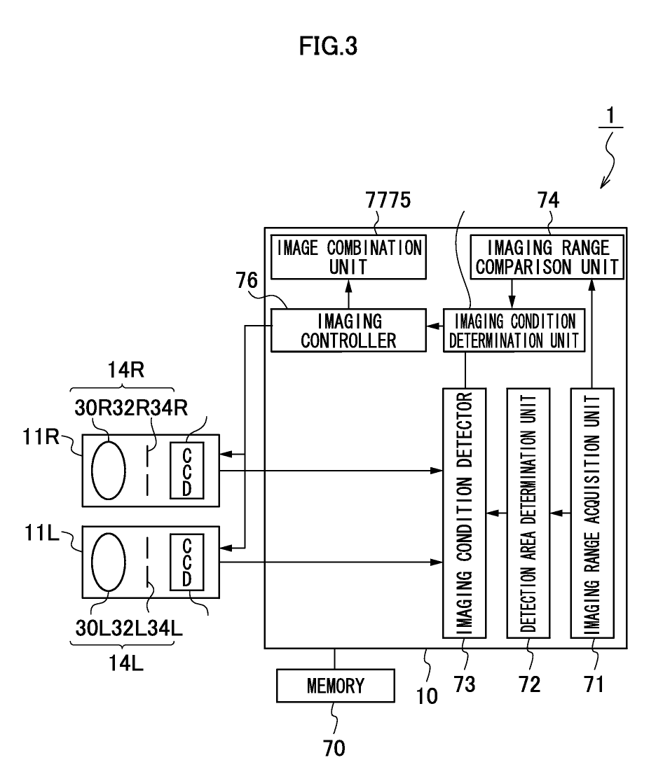

FIG. 3 is a principal block diagram of a digital camera 1 in a first embodiment. Elements having been shown in FIG. 1 are assigned with the identical numerals. The description on the points having already been described will hereinafter be omitted.

A memory 70 is a device for storing various pieces of information. In this embodiment, the memory 70 includes the ROM 16, the flash ROM 18 and the SDRAM 20 in FIG. 1.

The CPU 10 in this embodiment includes an imaging range acquisition unit 71, a detection area determination unit 72, an imaging condition detector 73, an imaging range comparison unit 74, an imaging condition determination unit 75, an imaging controller 76 and an image combination unit 77.

The imaging range acquisition unit 71 acquires imaging range information from the memory 70. The imaging range information indicates a range to be recorded (hereinafter, referred to as an “imaging range”) among the entire taken image obtained by imaging through the imaging system 11R and 11L.

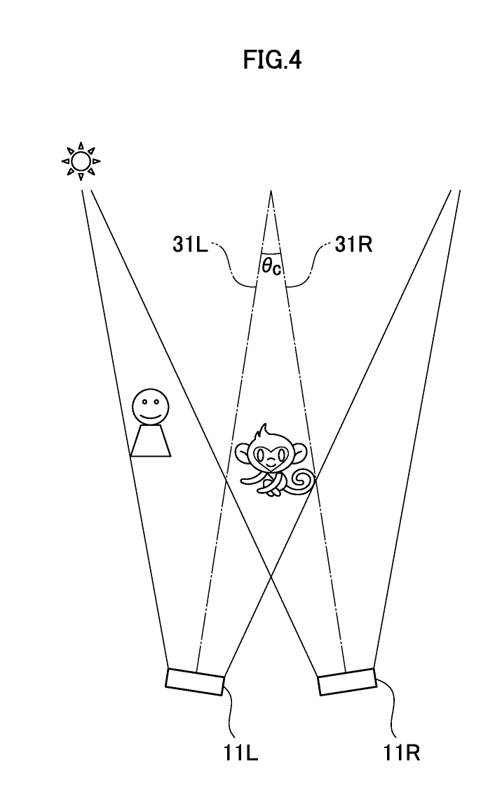

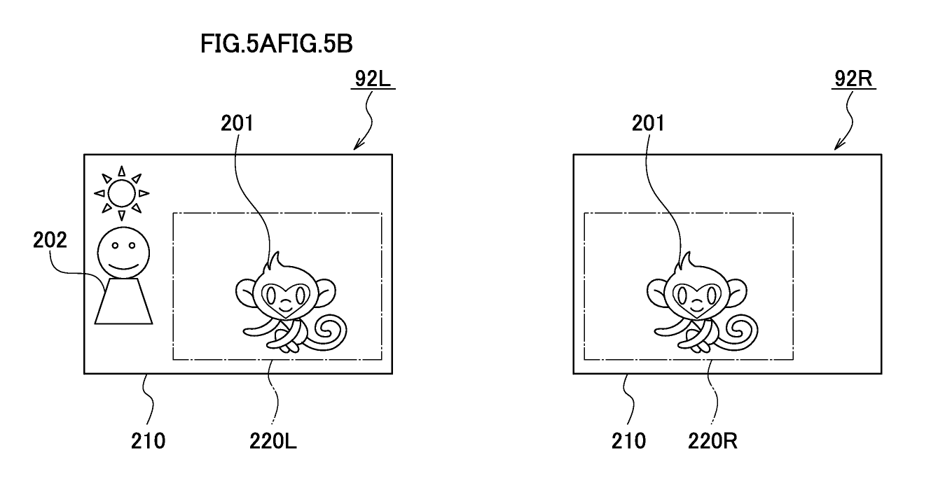

The imaging range of a 2D image and the imaging range of a 3D image are herein described using FIGS. 4 and 5A and 5B. For example, in an imaging scene shown in FIG. 4, the left taken image 92L shown in FIG. 5A is generated by the left imaging system 11L, and the right taken image 92R shown in FIG. 5B is generated by the right imaging system 11R. The entire region 210 (hereinafter, referred to as an “image area”) of the left taken image 92L in FIG. 5A is recorded as an imaging range of a 2D image. Accordingly, a 2D image including not only a principal subject (main subject) 201 (a monkey in this example) but also a secondary subject (sub-subject) 202 (a person in this example) can be recorded. Further, in the left taken image 92L shown in FIG. 5A and the right taken image 92R shown in FIG. 5B, cut-out regions 220L and 220R, which share the subject and have a specific length-to-width ratio (aspect ratio), are recorded as the imaging range of the 3D image. Accordingly, the 3D image sufficient for stereoscopy of the principal subject 201 can be recorded. That is, the 2D image is preferably recorded as wide as the imaging range corresponding to the effective pixel region (image area) because the 2D image is not required to be stereoscopically displayed; the 3D image is preferably recorded over the cut-out region smaller than the effective pixel region in order to allow stereoscopy later in a sufficient and easy manner. In such a case, the imaging range 210 of the 2D image becomes wider than the imaging ranges 220L and 220R of the 3D image.

In the 3D image, when the amount of binocular parallax (AP in FIG. 2B) is adjusted by shifting the pixels of the left taken image and the right taken image according to an instruction input from the operation unit 12, the imaging range of the 3D image is changed according to the shift amount of pixels (pixel shift amount). In these cases, the imaging range of the 3D image is calculated on the basis of the shift amount of pixels. Also in cases where the digital camera 1 has a structure whose convergence angle (θc in FIG. 2A) and base line length (SB in FIG. 2A) can be changed, the imaging range of the 3D image is changed. In such a case, the imaging range of the 3D image is calculated on the basis of parameters changeable with respect to the structure (e.g. θc). Further, in a case capable of changing the imaging range of the 2D image according to an instruction input from the operation unit 12, the imaging range of the 2D image is acquired.

A detection area determination unit 72 determines an area (hereinafter, simply referred to as the “detection area”) where an imaging condition is detected in the image area on the basis of the imaging range information. In this example, the imaging range of the 2D image and the imaging range of the 3D image are different from each other. Accordingly, different detection areas are determined between the 2D image and the 3D image.

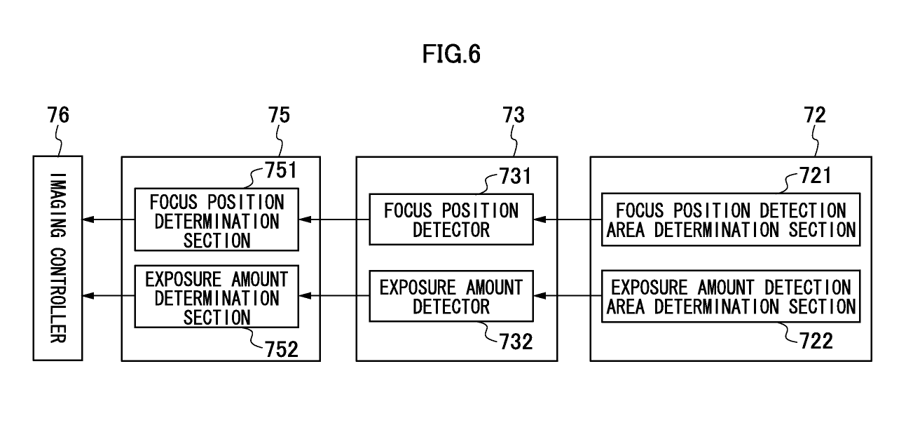

As shown in FIG. 6, the detection area determination unit 72 includes a focus position detection area determination section 721 which determines an area (hereinafter, referred to as a “focus position detection area”) for detecting the lens position (focus position) where the focusing lenses 30F (30FL and 30FR) are focused on the subject, and an exposure amount detection area determination section 722 which determines an area (hereinafter, referred to as an “exposure amount detection area”) for detecting the exposure amount.

The imaging condition detector 73 detects an imaging condition in the detection area determined by the detection area determination unit 72. More specifically, the imaging condition detector 73 detects the imaging condition in the detection area (detection area of the 2D image) corresponding to the imaging range of the 2D image in a case of the 2D image, and detects the imaging condition in the detection area (detection area of the 3D image) corresponding to the imaging range of the 3D image in a case of the 3D image.

As shown in FIG. 6, the imaging condition detector 73 includes a focus position detector 731 which detects the focus position in the focus position detection area, and an exposure amount detector 732 which detects the exposure amount in the exposure amount detection area.

The focus position detector 731 detects the focus position PA (hereinafter, referred to as a “first focus position”) in the focus position detection area corresponding to the imaging range of the 2D image, and detects the focus position PB (hereinafter, referred to as a “second focus position”) in the focus position detection area corresponding to the imaging range of the 3D image.

The exposure amount detector 732 detects the exposure amount EVA (hereinafter, referred to as a “first exposure amount”) in the exposure amount detection area corresponding to the imaging range of the 2D image, and detects the exposure amount EVB (hereinafter, referred to as a “second exposure amount”) in the exposure amount detection area corresponding to the imaging range of the 3D image.

An imaging range comparison unit 74 compares the imaging range of the 2D image and the imaging range of the 3D image.

An imaging condition determination unit 75 compares the imaging condition detected in the detection area of the 2D image (i.e., the imaging condition corresponding to the imaging range of the 2D image) and the imaging condition detected in the detection area of the 3D image (i.e., the imaging condition corresponding to the imaging range of the 3D image), and determines usage modes of the detected imaging conditions.

As shown in FIG. 6, the imaging condition determination unit 75 includes a focus position determination section 751 which determines a usage mode of the focus position detected by the focus position detector 731, and an exposure amount determination section 752 which determines the usage mode of the exposure amount detected by the exposure amount detector 732.

The focus position determination section 751 compares a difference ΔP=|PA−PB| (hereinafter, referred to as a “focus position difference”) between the first focus position PA corresponding to the imaging range of the 2D image and the second focus position PB corresponding to the imaging range of the 3D image and depths of field of the imaging optical systems 14L and 14R.

Here, the depth of field is the front depth of field or the rear depth of field. For example, with reference to the PB, if PA is positioned in the front of PB, ΔP and the front depth of field are compared; if PA is positioned in the rear of PB, ΔP and the rear depth of field are compared. Needless to say, the comparison is made with conformity of units between the focus positions PA and PB and the depths of field. In this embodiment, the depth of field is conformed to the focus position (the position of the focusing lens). Instead, the focus position (the position of the focusing lens) may be conformed to the depth of field.

If the focus position difference ΔP≦the depth of field, the focus position determination section 751 of this embodiment determines to acquire both of the 2D image and the 3D image in the focus position (PB in this example) corresponding to the image whose imaging range is smaller between the first focus position PA and the second focus position PB. On the other hand, if the focus position difference ΔP>the depth of field, the focus position determination section 751 determines to acquire the 2D image in the first focus position PA corresponding to the image range of the 2D image and to acquire the 3D image in the focus position PB corresponding to the image range of the 3D image,

The exposure amount determination section 752 compares the difference ΔEV=|EVA−EVB| (hereinafter, referred to as an “exposure amount difference”) between the first exposure amount EVA corresponding to the imaging range of the 2D image and the second exposure amount EVB corresponding to the 3D image and a threshold Th preliminarily stored in the memory 70.

If the exposure amount difference ΔEV≦the threshold, the exposure amount determination section 752 of this embodiment determines to take the 2D image and the 3D image with the exposure amount (EVB in this example) corresponding to the image whose imaging range is smaller between the first exposure amount EVA and the second exposure amount EVB. If the exposure amount difference ΔEV>the threshold, the exposure amount determination section 752 of this embodiment determines to take the 2D image with the first exposure amount EVA and to take the 3D image with the second exposure amount EVB.

An imaging controller 76 controls the imaging systems 11L and 11R according to the determination result by the imaging condition determination unit 75, and takes the 2D image and the 3D image.

An image combination unit 77 performs multiframe combination. In the multiframe combination, the pixel values are added pixel-by-pixel bases among a plurality of frames of the image.

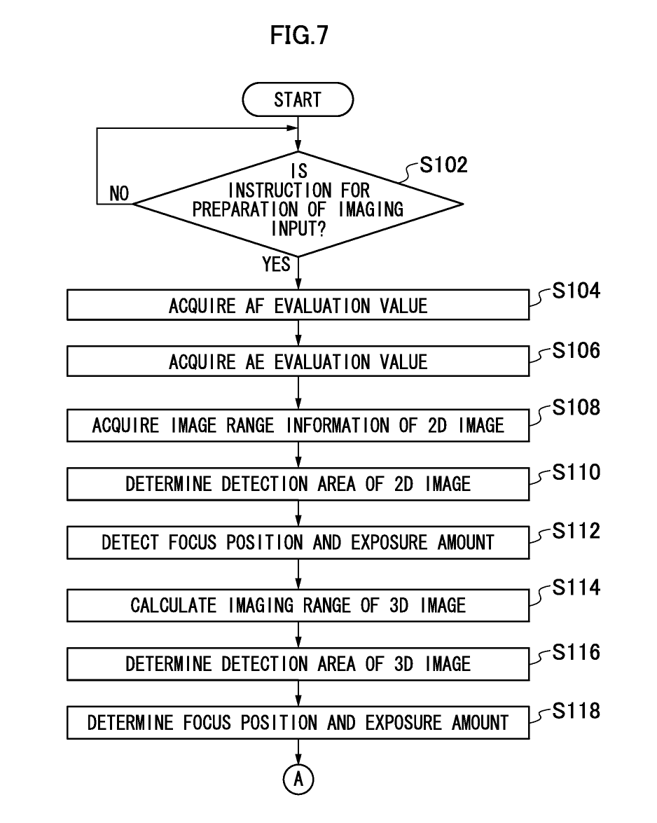

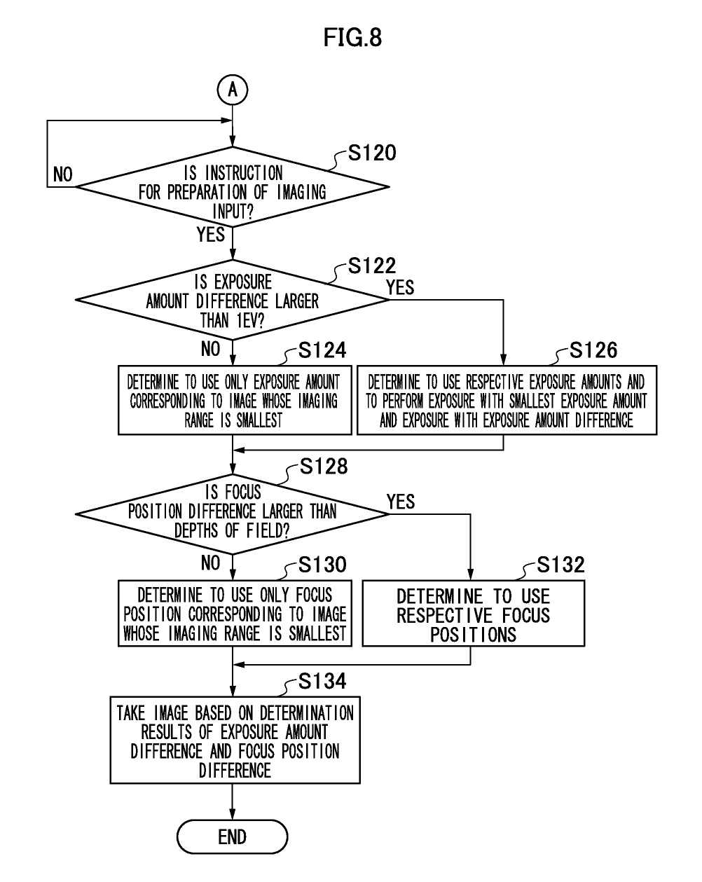

Next, an example of an imaging process in the first embodiment will be described using mainly flowcharts of FIGS. 7 and 8.

In step S102, an input of an instruction for preparation of imaging is waited for. In this embodiment, when the shutter release button is half-pressed, it is determined that an instruction for imaging is input, and the processing proceeds to step S104.

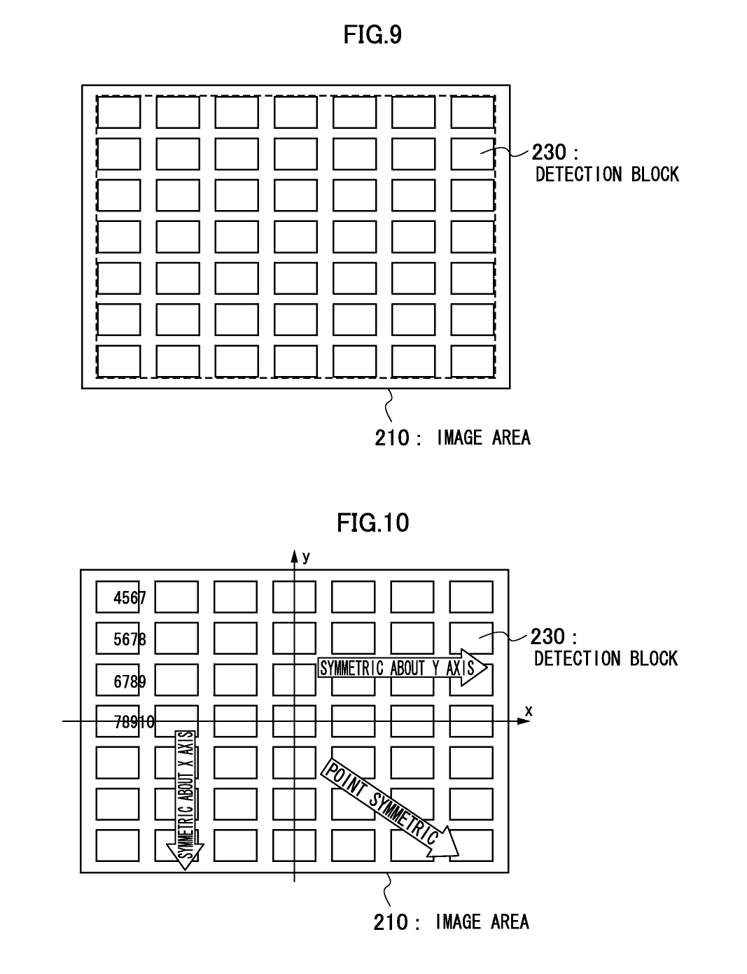

In step S104, the AF evaluation value acquisition unit (44 in FIG. 1) acquires the AF evaluation value representing degrees of focus of the focusing lens 30F with respect to each of detection blocks 230 (block-by-block bases) in the image area 210 shown in FIG. 9. For example, the AF evaluation value acquisition unit calculates the AF evaluation value (focus evaluation value) representing contrast of images with respect to each of the detection blocks 230 while moving the focusing lenses. The calculated evaluation values of the respective detection blocks 230 are stored in the memory 70. FIG. 9 exemplarily illustrates a case where 7×7 detection blocks 230 are set in the image area 210. However, the number and arrangement of detection blocks 230 are not specifically limited. In the example in FIG. 9, gaps are provided between the detection blocks. Accordingly, the imaging condition can widely be detected, while the size of the detection block 230 is minimized and the evaluation value calculation process for each of the detection block 230 to alleviate. A mode where no gap is provided between the detection blocks 230 may be employed instead.

In step S106, the AE/AWB evaluation value acquisition unit (46 in FIG. 1) acquires the AE evaluation value for each of the detection blocks 230 in the image area 210 shown in FIG. 9. For example, the AE/AWB evaluation value acquisition unit calculates luminance values as the AE evaluation value and the AWB evaluation value with respect to each of the detection blocks 230. The calculated evaluation value for each detection block 230 is stored in the memory 70.

In step S108, the imaging range acquisition unit 71 acquires the imaging range information of the 2D image from the memory 70. In this example, as described using FIG. 5A, the entire image area 210 is the imaging range of the 2D image. The image area is the effective pixel region where performance is secured in the entire pixel regions of the imaging elements 34L and 34R. In this example, information representing the range of the effective pixel regions has preliminarily been stored as imaging range information for 2D, in the memory 70. In a case where the imaging range of the 2D image can be designated by an input through the operation unit 12, the designated imaging range is stored in the memory 70.

In step S110, the detection area determination unit 72 determines the detection area corresponding to the imaging range of the 2D image. If the entire image area 210 is the imaging range of the 2D image, the all detection blocks 230 in the image area 210 are specified as detection objects (detection targets) of the imaging conditions (including the focus position and the exposure amount) as shown in FIG. 9. In FIG. 10, numbers in the blocks represent weights assigned to the evaluation values of the respective blocks. As shown in FIG. 10, in this example, the weights are symmetrically specified with respect to the x axis and the y axis and the central point.

In step S112, the imaging condition detector 73 detects the first focus position PA and the first exposure amount EVA in the detection area of the 2D image. In this example, the weights shown in FIG. 9 are applied to the detected AF evaluation values with respect to each of the detection blocks 230 belonging to the image area 210 of the 2D image, and subsequently the total sum is taken in the entire image area 210, thereby calculating the AF evaluation value in the entire detection area of the 2D image. The position of the focusing lens where the AF evaluation value becomes the local-maximum is detected as the focus position. The AE evaluation values are also weighted as with the AF evaluation values, and the exposure amount is calculated on the basis of the total sum of the entire image area 210.

In step S114, the imaging range acquisition unit 71 calculates the imaging range information of the 3D image on the basis of the parameters of the 3D imaging. Variable parameters of the 3D imaging include the shift amount of pixels for adjusting the amount of binocular parallax. Since the shift amount of pixels has preliminarily been stored in the memory 70 according to the instruction input from the operation unit 12, the amount is acquired therefrom. In cases where the convergence angle θc and the base line length SB are variable, the imaging range information is calculated on the basis of these variable parameters.

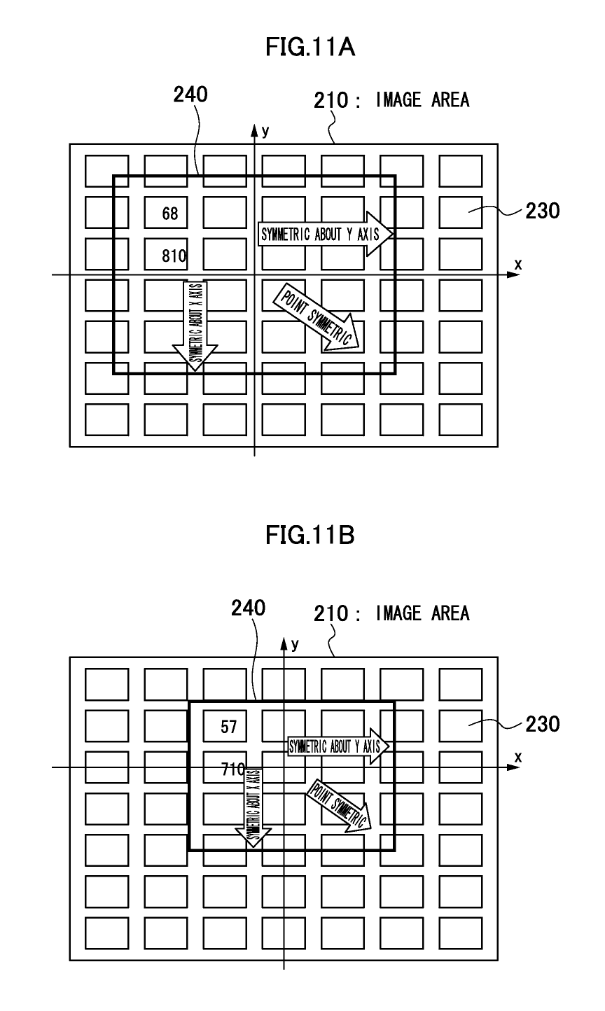

In step S116, the detection area determination unit 72 determines the detection area corresponding to the imaging range of the 3D image. For example, as shown in FIG. 11A, the 4×4 detection blocks corresponding to the imaging range of the 3D image in the 7×7 detection blocks 230 in the image area 210 are specified as the detection object for the imaging condition. That is, an area designated by reference numeral 240 is the detection area of the 3D image. FIG. 11B shows a case where the 3×3 detection blocks are specified as the detection object for the imaging condition. In FIGS. 11 and 11B, numbers in the blocks represent weights assigned to the evaluation values of the respective blocks.

In step S118, the imaging condition detector 73 detects the second focus position PB and the second exposure amount EVB in the detection area of the 3D image. In this example, the weights shown in FIG. 11A or 11B are applied to the detected AF evaluation values for respective detection blocks 230 belonging to the detection area 240 of the 3D image, and subsequently the total sum is taken in the entire image area 240, thereby calculating the AF evaluation value in the entire detection area of the 3D image. The position of the focusing lens where the AF evaluation value becomes the local-maximum is detected as the focus position. The AE evaluation values are also weighted as with the AF evaluation values, and the exposure amount is calculated on the basis of the total sum of the entire image area 240.

The case of acquiring the evaluation values for respective detection blocks 230 commonly between the 2D and 3D (steps S104 and S106) and separately calculating the imaging conditions (the exposure amount and the focus position) (steps S112 and S118) has exemplarily been described using FIGS. 9 to 11B. Accordingly, the optimal imaging conditions can be detected for the respective 2D and 3D with the different imaging ranges, and only one operation is sufficient to acquire the evaluation value. This enables the speed of the imaging condition detection process to be enhanced. However, the preset invention is not limited such a case, but includes a case of acquiring the evaluation values of the 2D and the 3D separately from each other.

In step S120, an instruction for imaging is waited for. In this embodiment, when the shutter release button is full-pressed, it is determined that the instruction for imaging is input, and the processing proceeds to step S122.

In step S122, the exposure amount determination section 752 compares the difference ΔEV (exposure amount difference) between the first evaluation amount EVA and the second exposure amount EVB with the threshold Th (1EV in this example). That is, it is determined whether the difference ΔEV=|EVA−EVB| between the first evaluation amount EVA corresponding to the imaging range of the 2D image and the second exposure amount EVB corresponding to the imaging range of the 3D image is within an acceptable range or not.

If the exposure amount difference ΔEV≦the threshold Th, the exposure amount determination section 752 determines to acquire both of the 2D image and the 3D image using only the exposure amount corresponding to the image whose imaging range is the smallest, in step S124. In this embodiment, it is determined to use only the second exposure value EVB for both of the exposure of the 2D image and the exposure of the 3D image.

If the exposure amount difference ΔEV>the threshold Th, the exposure amount determination section 752 determines to take the 2D image with the first exposure amount EVA and to take the 3D image with the second exposure amount EVB in step S126. Note that, it is determined to perform exposure according to an exposure amount which is the smaller one of the first exposure value EVA and the second exposure value EVB and to perform exposure according to the exposure amount difference ΔEV, as described later. In actuality, the exposure amount is determined according to an exposure time (or a shutter speed), an aperture value and a sensitivity (degree of amplification). For example, in a case where the aperture value and the sensitivity are common to EVA and EVB, the exposure with the shorter exposure time (faster shutter speed) between EVA and EVB and exposure according to ΔEV are performed.

In step S128, the focus position determination section 751 compares the difference ΔP (focus position difference) between the first focus position PA and the second focus position PB with the depths of field of the imaging optical systems 14L and 14R. More specifically, it is determined whether the difference ΔP=|PA−PB| between the first focus position PA corresponding to the imaging range of the 2D image and the second focus position PB corresponding to the imaging range of the 3D image is within the acceptable range or not.

If the focus position difference ΔP>the depth of field, the focus position determination section 751 determines to acquire both of the 2D image and the 3D image using only the focus position corresponding to the image whose imaging range is the smallest, in step S130. In this example, it is determined to use only the second focus position PB for focusing of the 2D image and the 3D image.

If the focus position difference ΔP>the depth of field, the focus position determination section 751 determines to acquire the 2D image in the first focus position PA and the 3D image in the second focus position PB in step S132.

In step S134, the imaging controller 76 controls the imaging systems 11L and 11R according to the determination results from the focus position determination section 751 and the exposure amount determination section 752, and thereby takes the 2D image and the 3D image.

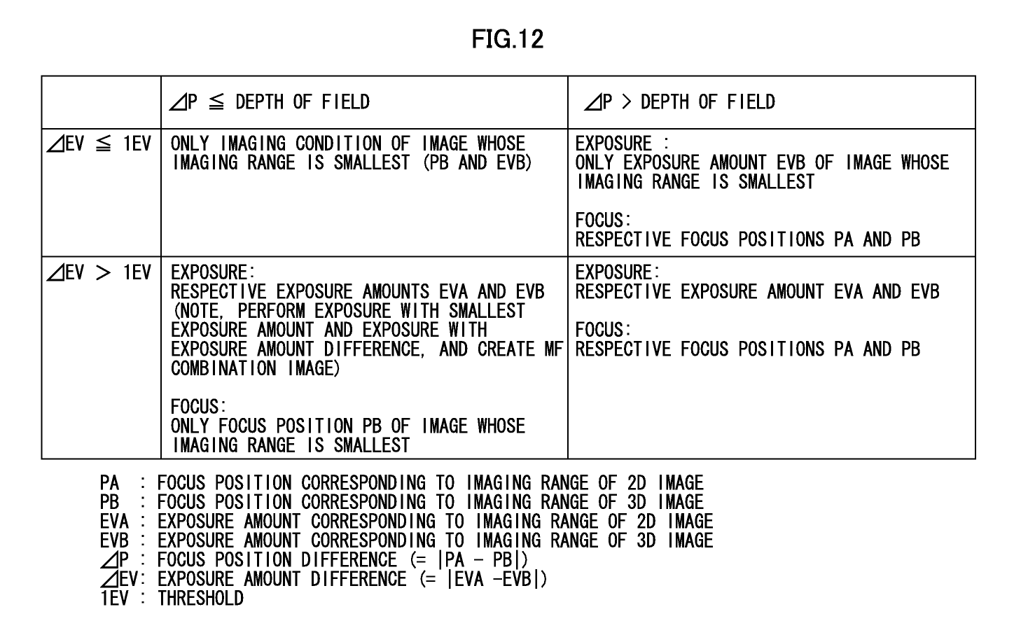

The imaging controller 76 in this embodiment performs control shown in FIG. 12.

If the exposure amount difference ΔEV≦1EV and the focus position difference ΔP≦the depth of field, both of the 2D image and the 3D image are taken using only the imaging condition corresponding to the image whose imaging range is the smallest. That is, both of the 2D image and the 3D image are taken by only one exposure using PB and EVB.

If the exposure amount difference ΔEV≦1EV and the focus position difference ΔP>the depth of field, the 2D image and the 3D image are taken using the exposure amount EVB corresponding to the image whose imaging range is the smallest and the respective focus positions PA and PB. That is, the 2D image is taken using PA and EVB, and the 3D image is taken using PB and EVB.

If the exposure amount difference ΔEV>1EV and the focus position difference ΔP≦the depth of field, the 2D image and the 3D image are taken using the respective amount of exposures EVA and EVB and the focus position PB corresponding to the image whose imaging range is the smallest. That is, the 2D image is taken using PB and EVA, and the 3D image is taken using PB and EVB. Note that a multiframe combined image is created, as will be described later.

If the exposure amount difference ΔEV>1EV and the focus position difference ΔP>the depth of field, the 2D image and the 3D images are taken under the respective imaging conditions. That is, the 2D image is taken using PA and EVA, and the 3D image is taken using PB and EVB.

The exposure amounts EVA and EVB and the exposure amount difference ΔEV will be exemplified. Examples 1 to 3 below are represented according to an order of the exposure amount of the larger one, the exposure amount of the smaller one, and the exposure amount difference ΔEV.

Example 1: 9.2 EV, 7.8 EV, and ΔEV=1.4 EV

Example 2: 6.4 EV, 2.8 EV, and ΔEV=3.6 EV

Example 3: 4.0 EV, 1.0 EV, and ΔEV=3.0 EV

In the Example 1, the first exposure is performed using the smaller exposure amount 7.8 EV, and the second exposure is performed using ΔEV=1.4 EV. Because the exposure time is typically very short when the exposure is ΔEV (the shutter speed is high), the time lag between the 2D image and the 3D image becomes significantly short.

The imaging controller 76 of this embodiment performs comparison with respect to the exposure time between one of the EVA and EVB whose exposure amount is smaller and the exposure amount difference ΔEV, performs the first exposure using the one of the exposure amount whose exposure time is longer, and performs the second exposure using the exposure amount whose exposure time is shorter. Instead, the imaging controller 76 may simply perform the comparison of the exposure amounts, and perform the first exposure using the larger exposure amount, and perform the second exposure using the smaller exposure amount. For example, in Example 3, the first exposure is performed using ΔEV=3.0 EV, and the second exposure is performed using 1.0 EV.

In this embodiment, the specific values of the aperture value, the exposure time (shutter speed) and the sensitivity can be determined using the same program diagram as a typical one.

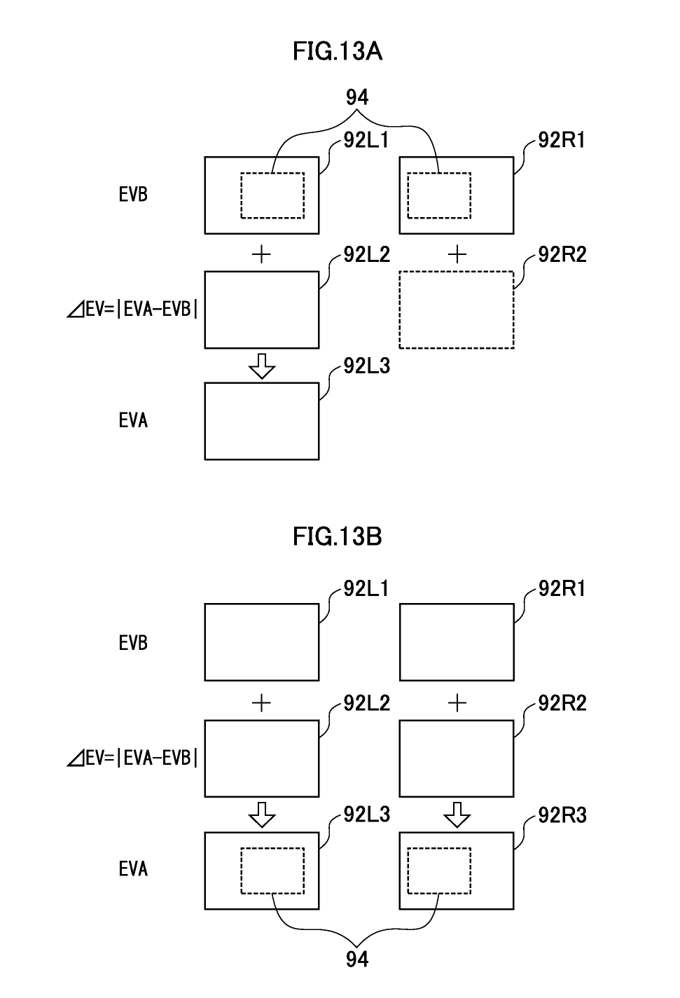

FIG. 13A is a diagram for illustrating multiframe combination in a case where EVA>EVB. The imaging controller 76 performs exposure with the exposure amount EVB, and generates the first left taken image 92L1 and the first right taken image 92R1. Next, the imaging controller 76 performs exposure with the exposure amount difference ΔEV, and generates the second left taken image 92L2 and the second right taken image 92R2. For the sake of power-saving, it is not necessarily to take the second right taken image 92R2. Next, the imaging controller 76 causes the image combination unit 77 to combine the first left taken image 92L1 and the second left taken image 92L2, and combine the first right taken image 92R1 and the second right taken image 92R2, thereby generating a third left taken image 92L3 (multiframe-combined image from a single viewpoint) equivalent to a case of exposure with the exposure amount EVA. In this embodiment, a cut-out image from the first left taken image 92L1 and a cut-out image from the first right taken image 92R1 configure the 3D display image 94 corresponding to the exposure amount EVB. The third taken image 92L3 configures the 2D image corresponding to the exposure amount EVA.

FIG. 13B is a diagram for illustrating multiframe combination in a case where EVA<EVB. The imaging controller 76 performs exposure with the exposure amount EVA, and generates the first left taken image 92L1 and the first right taken image 92R1. Next, the imaging controller 76 performs exposure with the exposure amount difference ΔEV, and generates the second left taken image 92L2 and the second right taken image 92R2. Next, the imaging controller 76 causes the image combination unit 77 to combine the first left taken image 92L1 and the second left taken image 92L2, and combine the first right taken image 92R1 and the second right taken image 92R2, thereby generating a third left taken image 92L3 and a third right taken image 92R3 equivalent to a case of exposure with the exposure amount EVB (multiframe-combined image from a plurality of viewpoints). In this embodiment, the first left taken image 92L1 configures the 2D image corresponding to the exposure amount EVA. A cut-out image from the third left taken image 92L3 and a cut-out image from the third right taken image 92R3 configure the 3D display image 94 corresponding to the exposure amount EVB.

Next, a second embodiment will be described.

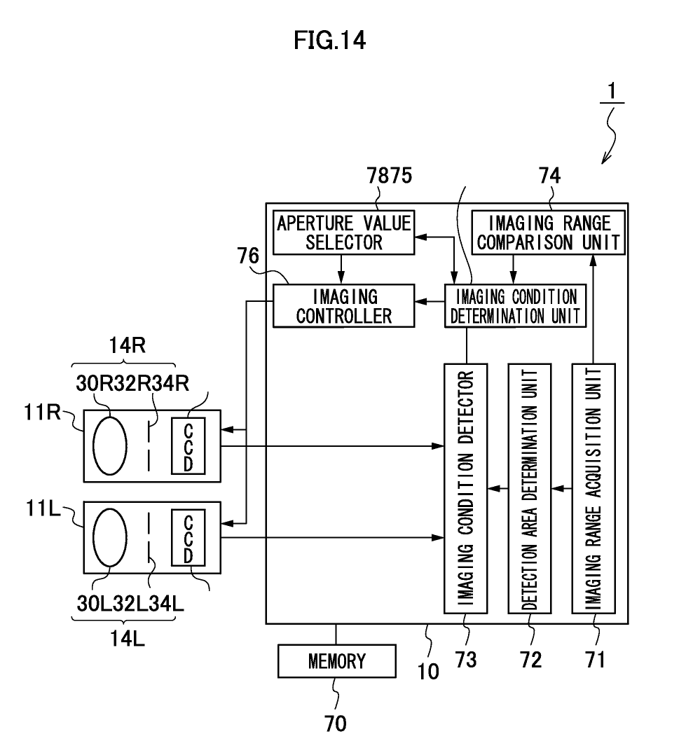

FIG. 14 is a principal block diagram of a digital camera 1 in the second embodiment. In FIG. 14, elements identical to the elements in the first embodiment shown in FIG. 3 are assigned with the identical numerals. Only points different from the first embodiment will hereinafter be described.

The memory 70 of this embodiment stores aperture value table information indicating a plurality of aperture values which can be set to the imaging optical systems 14L and 14R.

An aperture value selector 78 reads the aperture value table information from the memory 70, and selects the aperture value which allows the focus position difference ΔP to be included in the depths of field of the imaging optical systems 14L and 14R from among the plurality of aperture value which can be set to the imaging optical systems 14L and 14R. The selected aperture value is supplied to the imaging controller 76, and set to the imaging optical systems 14L and 14R by the imaging controller 76.

As shown in FIG. 6, the imaging condition determination unit 75 includes the focus position determination section 751 and the exposure amount determination section 752.

When the aperture value which satisfies the focus position difference ΔP≦the depth of field does not exist, the focus position determination section 751 of this embodiment determines to acquire the 2D image in the first focus position PA corresponding to the imaging range of the 2D image and to acquire the 3D image in the second focus position PB corresponding to the imaging range of the 3D image. When the aperture value which satisfies the focus position difference ΔP≦the depth of field exists, the focus position determination section 751 determines to acquire both of the 2D image and the 3D image in the focus position (PB in this example) corresponding to the image whose imaging range is smaller between the first focus position PA and the second focus position PB.

When the exposure amount difference ΔEV the threshold, the exposure amount determination section 752 of this embodiment determines to take the 2D image and the 3D image with the exposure amount (EVB in this example) corresponding to the image whose imaging range is smaller between the first exposure amount EVA and the second exposure amount EV. When the exposure amount difference ΔEV>the threshold, the exposure amount determination section 752 of this embodiment determines to take the 2D image with the first exposure amount EVA and to take the 3D image with the second exposure amount with the second exposure amount EVB.

The imaging controller 76 controls the imaging systems 11L and 11R according to the determination result from the imaging condition determination unit 75, and takes the 2D image and the 3D image. Further, the imaging controller 76 of this embodiment sets the aperture value selected by the aperture value selector 78 to the imaging optical systems 14L and 14R.

Next, an example of an imaging process in the second embodiment will be described.

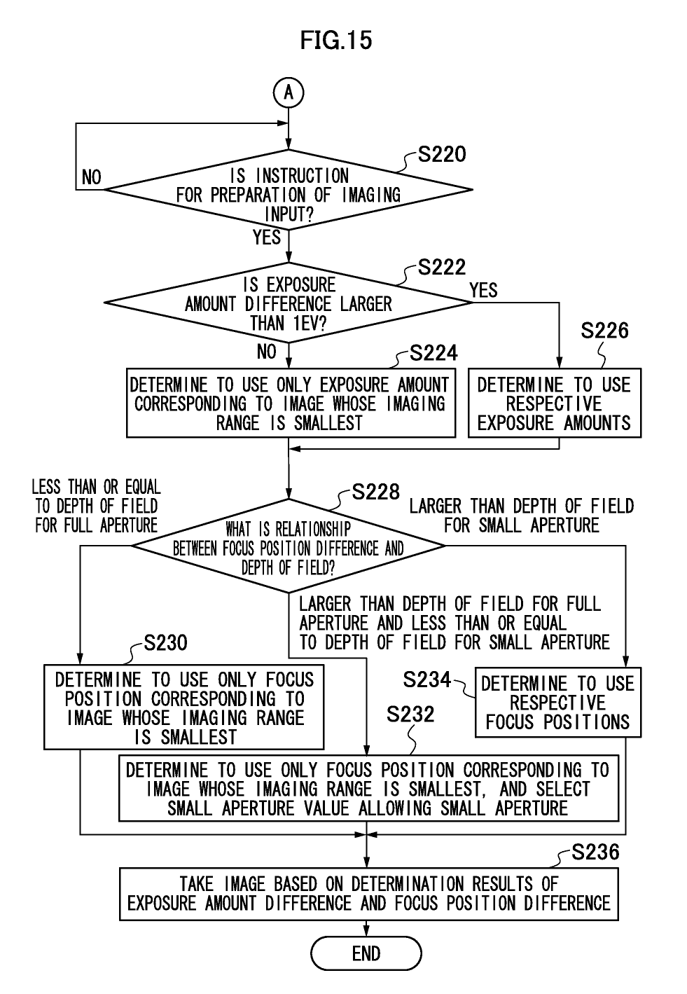

In this imaging process, first, the process shown in the flowchart of FIG. 7 (steps S102 to S118) is performed as with the first embodiment. Next, a process shown in a flowchart of FIG. 15 (steps S220 to S236) is performed.

In step S220, an input of an instruction for imaging is waited for. In this embodiment, when the shutter button is full-pressed, it is determined that the instruction for imaging is input, and the processing proceeds to step S222.

In step S222, the exposure amount determination section 752 compares the difference ΔEV (exposure amount difference) between the first evaluation amount EVA and the second exposure amount EVB with the threshold Th. The threshold is, for example, 1EV.

If the exposure amount difference ΔEV≦the threshold Th, the exposure amount determination section 752 determines to acquire both of the 2D image and the 3D image using only the exposure amount corresponding to the image whose imaging range is the smallest, in step S224. In this example, it is determined to use only the second exposure value EVB for both of the exposure of the 2D image and the exposure of the 3D image.

If the exposure amount difference ΔEV>the threshold Th, the exposure amount determination section 752 determines to take the 2D image with the first exposure amount EVA and the 3D image with the second exposure amount EVB in step S226.

In step S228, the focus position determination section 751 compares the difference ΔP (focus position difference) between the first focus position PA and the second focus position PB with the depths of field of the imaging optical systems 14L and 14R. In this embodiment, the focus position difference ΔP is compared with each of the depth of field for full aperture and the depth of field for small aperture.

If the focus position difference ΔP≦the depth of field for full aperture, the focus position determination section 751 determines to use only the focus position corresponding to the image whose imaging range is the smallest, in step S230. In this example, it is determined to use only the second focus position PB for focusing of both the 2D image and the 3D image.

If the depth of field for full aperture<the focus position difference ΔP<the depth of field for small aperture, the focus position determination section 751 determines to use only the focus position corresponding to the image whose imaging range is the smallest, in step S232. In this example, it is determined to use only the second focus position PB for focusing of the 2D image and 3D image. The aperture value selector 78 selects the aperture value allowing the apertures 32L and 32R of the imaging optical systems 14L and 14R to be small aperture.

If the depth of field for small aperture <the focus position difference ΔP, the focus position determination section 751 determines to take the 2D image using the first focus position PA and to take the 3D image using the second focus position PB in step S234.

The imaging controller 76 controls the imaging systems 11L and 11R according to the determination results by the focus position determination section 751 and the exposure amount determination section 752 and thereby takes the 2D image and the 3D image in step 236.

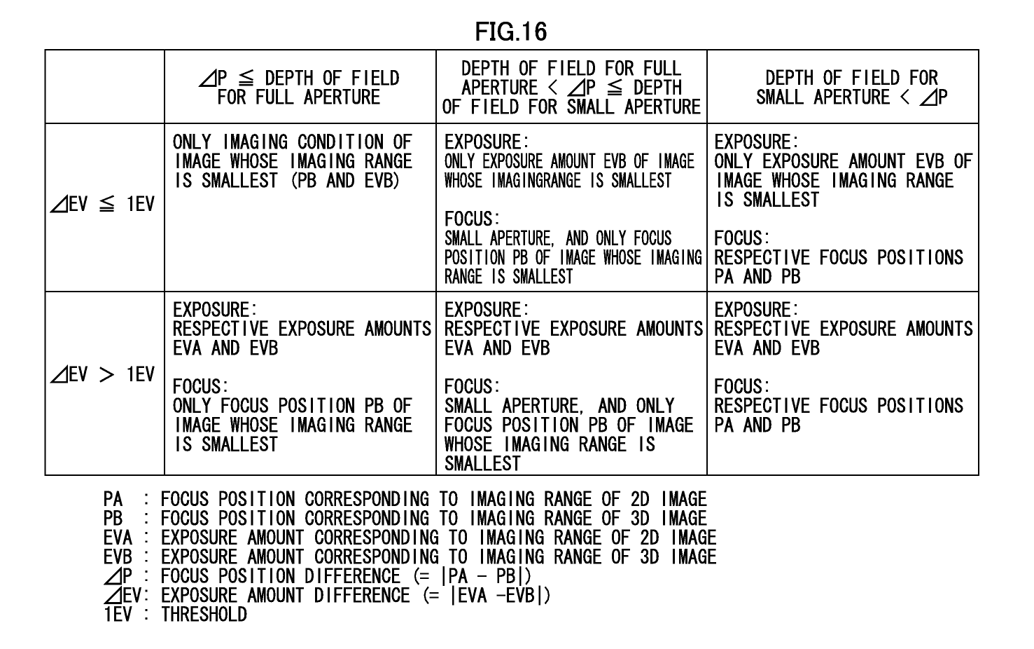

The imaging controller 76 of this embodiment performs control shown in FIG. 16.

If the exposure amount difference ΔEV≦1EV and the focus position difference ΔP≦the depth of field for full aperture, the 2D image and the 3D image are taken using only the imaging condition corresponding to the image whose imaging range is the smallest. That is, both of the 2D image and the 3D image are taken by only one exposure using PB and EVB.

If the exposure amount difference ΔEV≦1EV and the depth of field for full aperture<the focus position difference ΔP≦the depth of field for small aperture, the 2D image and the 3D image are taken using only the image condition (focus position PB and exposure amount EVB) corresponding to the image whose imaging range is the smallest under small aperture. That is, both of the 2D image and the 3D image are taken by one exposure using PB and EVB.

If the exposure amount difference ΔEV≦1EV and the depth of field for small aperture <the focus position difference ΔP, the 2D image and the 3D image are taken using the exposure amount EVB corresponding to the image whose imaging range is the smallest and the respective focus positions PA and PB. In this example, the 2D image is taken using PA and EVB, and the 3D image is taken using PB and EVB.

If the exposure amount difference ΔEV>1EV and the focus position difference ΔP≦the depth of field for full aperture, the 2D image and the 3D images are taken using the respective exposure amounts EVA and EVB and the focus position PB corresponding to the image whose imaging range is the smallest. That is, the 2D image is taken using PB and EVA, and the 3D image is taken using PB and EVB.

If the exposure amount difference ΔEV>1EV and the depth of field for full aperture<the focus position difference ΔP≦the depth of field for small aperture, the 2D image and the 3D image are taken using the focus position PB corresponding to the image whose imaging range is the smallest with small aperture set. That is, the 2D image is taken using PB and EVA, and the 3D image is taken using PB and EVB.

If the exposure amount difference ΔEV>1EV and the depth of field for small aperture <the focus position difference ΔP, the 2D image and the 3D image are taken under the respective imaging conditions. That is, the 2D image is taken using PA and EVA, and the 3D image is taken using PB and EVB.

Next, an example of small aperture will be described.

In a case of two-step aperture (e.g., F2.8 and F8.0), control is performed as described below.

(1a) In a case where ΔP≦the depth of field of F2.8, imaging is performed in the focus position PB.

(1b) In a case where the depth of field of F2.8<ΔP the depth of field of F8.0, imaging is performed with the aperture value F8.0 in the focus position PB.

(1c) In a case where the depth of field of F8.0<ΔP, imaging is performed in each of the focus positions PA and PB.

That is, in the cases (1a) and (1b), if the difference between the other imaging conditions (exposure amount difference ΔEV in this embodiment) is within the acceptable range, both of the 2D image and the 3D image are taken using the same focus position PB by imaging with one exposure.

In a case of three-step aperture (e.g., F2.8, F5.6 and F8.0), control is performed as described below.

(2a) In a case where ΔP≦the depth of field of F2.8, imaging is performed in the focus position PB.

(2b) In a case where the depth of field of F2.8<ΔP≦the depth of field of F8.0, imaging is performed with any one of the aperture values F5.6 and F8.0 in the focus position PB.

(2c) In a case where the depth of field of F8.0<ΔP, imaging is performed in each of the focus positions PA and PB.

That is, in the cases (2a) and (2b), if the difference between the other imaging conditions (exposure amount difference ΔEV in this embodiment) is within the acceptable range, both of the 2D image and the 3D image are taken using the same focus position PB by imaging with one exposure.

Next, a third embodiment will be described.

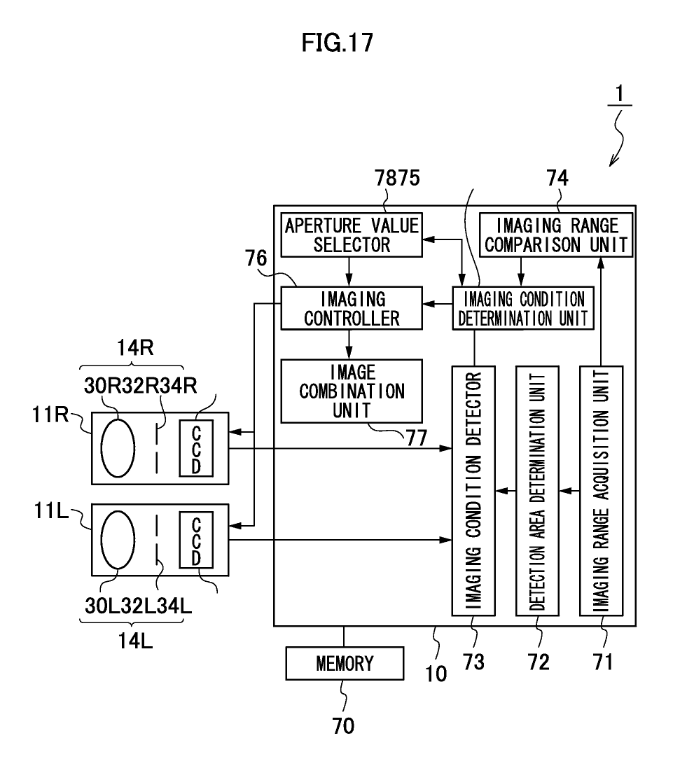

FIG. 17 is a principal block diagram of a digital camera 1 in the third embodiment. In FIG. 17, elements identical to the elements in the first embodiment shown in FIG. 3 and elements identical to the elements in the second embodiment shown in FIG. 14 are assigned with the identical numerals. Only points specific to this embodiment will hereinafter be described.

The digital camera 1 of this embodiment includes the image combination unit 77 described in the first embodiment, and the aperture value selector 78 described in the second embodiment.

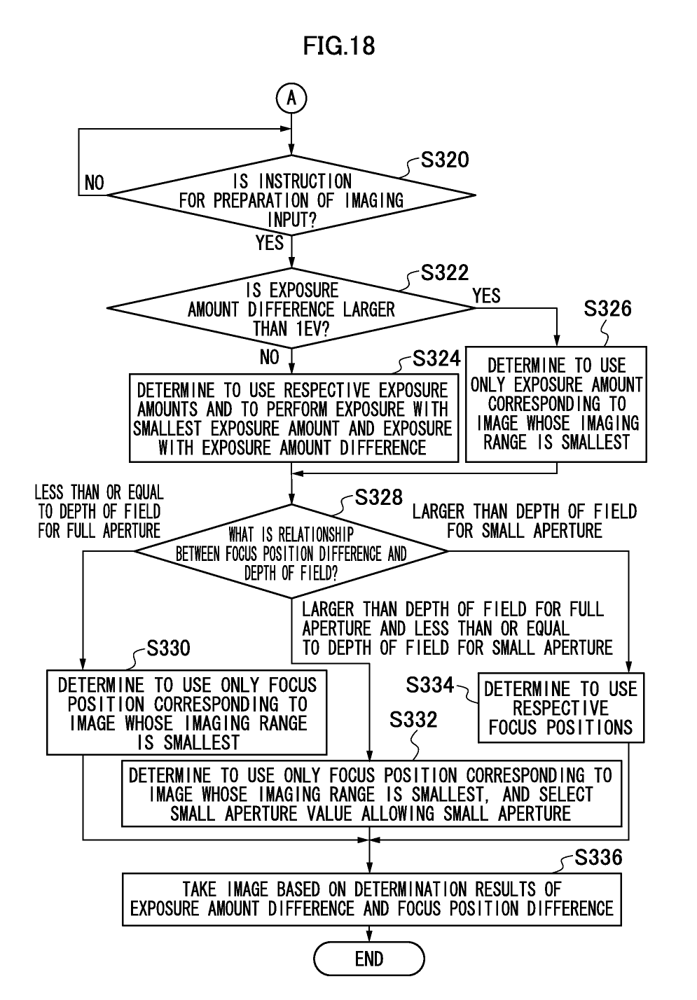

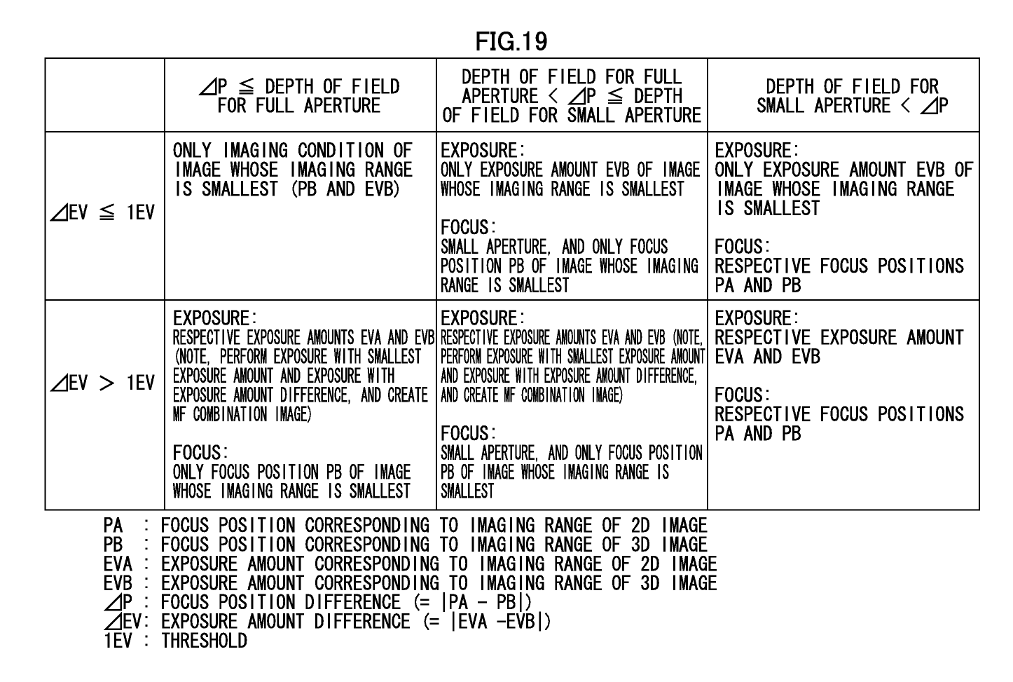

An example of an imaging process in the third embodiment will be described. In this imaging process, first, the process (steps S102 to S118) shown in the flowchart of FIG. 7 is performed as with the first embodiment. Next, the process (steps S320 to S336) shown in the flowchart of FIG. 18 is performed.

The steps S320 to S326 are substantially identical to the steps S120 to S126 in the first embodiment. The steps S328 to S334 are substantially identical to the steps S228 to 5234 in the second embodiment.

In step S336, the imaging controller 76 performs control shown in FIG. 16.

The process in the case where the exposure amount difference ΔEV≦1EV is substantially identical to the process in the second embodiment. The description thereof is herein omitted.

The process in the case where the exposure amount difference ΔEV>1EV and the focus position difference ΔP≦the depth of field for full aperture is substantially identical to the process where the exposure amount difference ΔEV>1EV and ΔP≦the depth of field in the first embodiment. The description thereof is herein omitted.

In a case where the exposure amount difference ΔEV>1EV and the depth of field for full aperture<the focus position difference ΔP≦the depth of field for small aperture, the 2D image and the 3D image are taken with small aperture using the focus position PB corresponding to the image whose imaging range is the smallest and the respective exposure amount EVA and EVB. Note that the multiframe combination described in the first embodiment is performed.

The process in the case where the exposure amount difference ΔEV>1EV and the focus position difference ΔP>the depth of field for small aperture is substantially identical to the process where the exposure amount difference ΔEV>1EV and ΔP>the depth of field in the first embodiment.

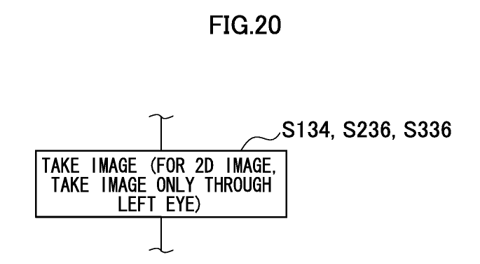

Next, a fourth embodiment will be described. In this embodiment, as shown in FIG. 20, the 2D image is taken by imaging only through the left eye in the imaging step. More specifically, the imaging controller 76 in this embodiment images the subject using only the left imaging system 11L when only taking the 2D image.

The imaging step corresponds to step S134 in the first embodiment, step S236 in the second embodiment and step S336 in the third embodiment. Since the other processes have been described in the first to third embodiments, the description thereof is herein omitted.

The case where the focus position and the exposure amount are detected as the imaging conditions has been described. However, an imaging condition (e.g., a white balance adjustment value) other than the focus position and the exposure amount may be detected.

The presently disclosed subject matter has been described using the example of the case of taking the still image. However, the presently disclosed subject matter is not limited to the imaging of the still image. Needless to say, the presently disclosed subject matter may also be applied to a case of taking moving images.

The presently disclosed subject matter is not limited to the examples described in this specification and illustrated in the figures. It is the matter of course that various modifications in design and improvements may be performed within a scope without departing from the gist of the presently disclosed subject matter.

What is claimed is:

1. A stereoscopic imaging apparatus capable of taking a planar image and a stereoscopic image, comprising:
a first imaging device having a first imaging optical system and a first imaging element imaging a subject through the first imaging optical system;
a second imaging device having a second imaging optical system and a second imaging element imaging the subject through the second imaging optical system;
an exposure amount detection device which detects a first exposure amount corresponding to an imaging range of the planar image and a second exposure amount corresponding to an imaging range of the stereoscopic image;
an exposure amount determination device which determines to acquire the planar image and the stereoscopic image with one of the first exposure amount and the second exposure amount corresponding to an image whose imaging range is smaller when a difference between the first exposure amount and the second exposure amount is smaller than or equal to a threshold, and determines to acquire the planar image with the first exposure amount and to acquire the stereoscopic image with the second exposure amount when the difference between the first exposure amount and the second exposure amount is larger than the threshold; and
a control device for controlling the first and the second imaging devices according to a determination result by the exposure amount determination device, the control device which acquires both of the planar image and the stereoscopic image by one exposure when the difference between the exposure amounts is smaller than or equal to the threshold, and performs exposure with the smaller one of the first exposure amount and the second exposure amount to generate a first taken image and performs exposure with the difference between the first exposure amount and the second exposure amount to generate a second taken image and combines the first taken image and the second taken image when the difference between the exposure amounts is larger than the threshold, if a difference of imaging conditions other than the exposure amount between the planar image and the stereoscopic image is within an acceptable range.

2. A stereoscopic imaging apparatus capable of taking a planar image and a stereoscopic image, comprising:
a first imaging device having a first imaging optical system and a first imaging element imaging a subject through the first imaging optical system;
a second imaging device having a second imaging optical system and a second imaging element imaging the subject through the second imaging optical system;
a focus position detection device which detects a first focus position corresponding to an imaging range of the planar image and a second focus position corresponding to an imaging range of the stereoscopic image;
an aperture value selection device which selects an aperture value where a difference between the first focus position and the second focus position is included in depths of field of the first and second imaging optical systems, from among a plurality of aperture values settable to the imaging optical systems;
a focus position determination device which determines to acquire the planar image in the first focus position and acquire the stereoscopic image in the second focus position when the aperture value where the difference between the focus positions is included in the depths of field does not exist, and determines to acquire the planar image and the stereoscopic image in a focus position corresponding to an image whose imaging range is smaller between the first focus position and the second focus position when the aperture value where the difference between the focus positions is included in the depths of field exists; and
a control device for controlling the first and second imaging devices according to a determination result by the focus position determination device, the control device which acquires both of the planar image and the stereoscopic image by one exposure when a difference of imaging conditions other than the focus position between the planar image and the stereoscopic image is within an acceptable range and when the difference between the focus positions is included within the depths of field.

3. A stereoscopic imaging apparatus capable of taking a planar image and a stereoscopic image, comprising:
a first imaging device having a first imaging optical system and a first imaging element imaging a subject through the first imaging optical system;
a second imaging device having a second imaging optical system and a second imaging element imaging the subject through the second imaging optical system;
an exposure amount detection device which detects a first exposure amount corresponding to an imaging range of the planar image and a second exposure amount corresponding to an imaging range of the stereoscopic image;
a focus position detection device which detects a first focus position corresponding to the imaging range of the planar image and a second focus position corresponding to the imaging range of the stereoscopic image;
an exposure amount determination device which determines to acquire the planar image and the stereoscopic image with one of the first exposure amount and the second exposure amount corresponding to an image whose imaging range is smaller when a difference between the first exposure amount and the second exposure amount is smaller than or equal to a threshold, and determines to acquire the planar image with the first exposure amount and to acquire the stereoscopic image with the second exposure amount when the difference between the first exposure amount and the second exposure amount is larger than the threshold;
an aperture value selection device which selects an aperture value where a difference between the first focus position and the second focus position is included in the depths of field of the first and second imaging optical systems, from among a plurality of aperture values settable to the imaging optical systems;
a focus position determination device which determines to acquire the planar image in the first focus position and acquire the stereoscopic image in the second focus position when the aperture value where the difference between the focus positions is included in the depths of field does not exist, and determines to acquire the planar image and the stereoscopic image in a focus position corresponding to an image whose imaging range is smaller between the first focus position and the second focus position when the aperture value where the difference between focus positions is included in the depths of field exists; and
a control device for controlling the first and second imaging devices according to determination results by the exposure amount determination device and the focus position determination device, the control device which acquires both of the planar image and the stereoscopic image by one exposure when the difference between the exposure amounts is smaller than or equal to the threshold, and performs exposure with a smaller one of the first exposure amount and the second exposure amount to generate a first taken image and performs exposure with the difference between the first exposure amount and the second exposure amount to generate a second taken image and combines the first taken image and the second taken image when the difference between the exposure amounts is larger than the threshold, if the difference between the focus positions is within the depths of field.

4. The stereoscopic imaging apparatus according to claim 1, wherein the exposure amount detection device divides the taken images of the first imaging device and the second imaging device into a plurality of blocks, acquires an evaluation value for detecting the exposure amount with respect to each of the blocks, detects the first exposure amount on the basis of the evaluation values of the plurality of blocks belonging to the imaging range of the planar image, detects the second exposure amount on the basis of the evaluation values of the plurality of blocks belonging to the imaging range of the stereoscopic image, and thereby detects both exposure amounts of the planar image and the stereoscopic image by one acquisition operation of evaluation values.

5. The stereoscopic imaging apparatus according to claim 2, wherein the focus position detection device divides the taken images of the first imaging device and the second imaging device into a plurality of blocks, acquires an evaluation value for detecting the focus position with respect to each of the blocks, detects the first focus position on the basis of the evaluation values of the plurality of blocks belonging to the imaging range of the planar image, detects the second focus position on the basis of the evaluation values of the plurality of blocks belonging to the imaging range of the stereoscopic image, and thereby detects both focus positions of the planar image and the stereoscopic image by one acquisition operation of evaluation values.

6. The stereoscopic imaging apparatus according to claim 1, wherein the control device images the subject through only one of the first imaging device and the second imaging device when taking only the planar image.

7. An imaging control method using a first imaging device having a first imaging optical system and a first imaging element imaging a subject through the first imaging optical system and generating a first taken image, and a second imaging device having a second imaging optical system and a second imaging element imaging the subject through the second imaging optical system and generating a second taken image, and taking a planar image and a stereoscopic image, comprising:
an exposure amount detection step for detecting a first exposure amount corresponding to an imaging range of the planar image and a second exposure amount corresponding to an imaging range of the stereoscopic image;
an exposure amount determination step for determining to acquire the planar image and the stereoscopic image with one of the first exposure amount and the second exposure amount corresponding to an image whose imaging range is smaller when a difference between the first exposure amount and the second exposure amount is smaller than or equal to a threshold, and determining to acquire the planar image with the first exposure amount and to acquire the stereoscopic image with the second exposure amount when the difference between the first exposure amount and the second exposure amount is larger than the threshold; and
a control step for controlling the first and second imaging devices according to a result of the exposure amount determination step, the control step which includes:
acquiring both of the planar image and the stereoscopic image by one exposure when the difference between the exposure amounts is smaller than or equal to the threshold; and performing exposure with a smaller one of the first exposure amount and the second exposure amount to generate a first taken image, performing exposure with the difference between the first exposure amount and the second exposure amount to generate a second taken image and combining the first taken image and the second taken image when the difference between the exposure amounts is larger than the threshold, if a difference of imaging conditions other than the exposure amount between the planar image and the stereoscopic image is within an acceptable range.

8. An imaging control method using a first imaging device having a first imaging optical system and a first imaging element imaging a subject through the first imaging optical system and generating a first taken image, and a second imaging device having a second imaging optical system and a second imaging element imaging the subject through the second imaging optical system and generating a second taken image, and taking a planar image and a stereoscopic image, comprising:
a focus position detection step for detecting a first focus position corresponding to an imaging range of the planar image and a second focus position corresponding to an imaging range of the stereoscopic image;
an aperture value selection step for selecting an aperture value where a difference between the first focus position and the second focus position is included in depths of field of the first and second imaging optical systems from among a plurality of aperture values settable to the first and second imaging optical systems;
a focus position determination step for determining to acquire the planar image in the first focus position and acquire the stereoscopic image in the second focus position when the aperture value where the difference between the focus positions is included in the depths of field does not exist, and determining to acquire the planar image and the stereoscopic image in a focus position corresponding to an image whose imaging range is smaller between the first focus position and the second focus position when the aperture value where the difference between the focus positions is included in the depth of fields exists; and
a control step for controlling the first and second imaging devices according to a result of the focus position determination step, the control step which includes acquiring both of the planar image and the stereoscopic image by one exposure when a difference of imaging conditions other than the focus position between the planar image and the stereoscopic image is within an acceptable range and when the difference between focus positions is included within the depths of field.

9. An imaging control method using a first imaging device having a first imaging optical system and a first imaging element imaging a subject through the first imaging optical system and generating a first taken image, and a second imaging device having a second imaging optical system and a second imaging element imaging the subject through the second imaging optical system and generating a second taken image, and taking a planar image and a stereoscopic image, comprising:
an exposure amount detection step for detecting a first exposure amount corresponding to an imaging range of the planar image and a second exposure amount corresponding to an imaging range of the stereoscopic image;
a focus position detection step for detecting a first focus position corresponding to the imaging range of the planar image and a second focus position corresponding to the imaging range of the stereoscopic image;
an exposure amount determination step for determining to acquire the planar image and the stereoscopic image with one of the first exposure amount and the second exposure amount corresponding to an image whose imaging range is smaller when a difference between the first exposure amount and the second exposure amount is smaller than or equal to a threshold, and determining to acquire the planar image with the first exposure amount and to acquire the stereoscopic image with the second exposure amount when the difference between the first exposure amount and the second exposure amount is larger than the threshold;
an aperture value selection step for selecting an aperture value where a difference between the first focus position and the second focus position is included in the depths of field of the first and second imaging optical systems, from among a plurality of aperture values settable to the imaging optical systems;
a focus position determination step for determining to acquire the planar image in the first focus position and acquire the stereoscopic image in the second focus position when the aperture value where the difference between the focus positions is included in the depths of field does not exist, and determining to acquire the planar image and the stereoscopic image in a focus position corresponding to an image whose imaging range is smaller between the first focus position and the second focus position when the aperture value where the difference between the focus positions is included in the depths of field exists; and
a control step for controlling the first and second imaging device according to a result of the exposure amount determination step and a result of the focus position determination step, the control step which includes: acquiring both of the planar image and the stereoscopic image by one exposure when the difference between the exposure amounts is smaller than or equal to the threshold; and performing exposure with a smaller one of the first exposure amount and the second exposure amount to generate a first taken image, performing exposure with the difference between the first exposure amount and the second exposure amount to generate a second taken image and combining the first taken image and the second taken image when the difference between the exposure amounts is larger than the threshold, if the difference between the focus positions is within the depths of field.

10. The imaging control method according to claim 7, wherein
the exposure amount detection step includes:
dividing the taken images of the first imaging device and the second imaging device into a plurality of blocks;
acquiring an evaluation value for detecting the exposure amount with respect to each of the blocks; and
detecting the first exposure amount on the basis of the evaluation values of the plurality of blocks belonging to the imaging range of the planar image, and detecting the second exposure amount on the basis of the evaluation values of the plurality of blocks belonging to the imaging range of the stereoscopic image, thereby detecting both exposure amounts of the planar image and the stereoscopic image by one acquisition operation of evaluation values.

11. The imaging control method according to claim 7, wherein
the focus position detection step includes:
dividing the taken images of the first imaging device and the second imaging device into a plurality of blocks;
acquiring an evaluation value for detecting the focus position with respect to each of the blocks; and
detecting the first focus position on the basis of the evaluation values of the plurality of blocks belonging to the imaging range of the planar image, and detecting the second focus position on the basis of the evaluation values of the plurality of blocks belonging to the imaging range of the stereoscopic image, thereby detecting both focus positions of the planar image and the stereoscopic image by one acquisition operation of evaluation values.

12. The imaging control method according to claim 7, wherein the control step includes imaging the subject through only one of the first imaging device and the second imaging device when taking only the planar image.
